(19) United States
(12) Patent Application Publication
(10) Pub. No.: US 2020/0299466 A1
(43) Pub. Date: Sep. 24, 2020

(54) PURE CONDUCTING POLYMER HYDROGEL AND HYDROGEL PRECURSOR MATERIALS HAVING EXTRAORDINARY ELECTRICAL, MECHANICAL AND SWELLING PROPERTIES AND METHODS OF MAKING

(71) Applicant: Massachusetts Institute of Technology, Cambridge, MA (US)

(72) Inventors: Xuanhe Zhao, Allston, MA (US); Hyunwoo Yuk, Cambridge, MA (US); Baoyang Lu, Cambridge, MA (US)

(21) Appl. No.: 16/807,533

(22) Filed: Mar. 3, 2020

Related U.S. Application Data
(60) Provisional application No. 62/813,097, filed on Mar. 3, 2019.

(51) Int. Cl. C08J 3/075; C08G 61/12; C08F 212/14; H01B 1/12

(52) U.S. Cl. CPC C08J 3/075; C08G 61/126; C08F 212/30; H01B 1/127; C08J 2325/06; C08G 2261/3247; C08G 2261/50; C08J 2365/00; C08G 2210/00

(57) ABSTRACT

Pure conducting hydrogel precursors and hydrogels formed of pure conducting polymer materials having a combination of high electrical conductivity, high stretchability, low Young's modulus, superior mechanical, electrical and electrochemical stability, and tunable swelling behaviors in wet physiological environments. The hydrogel precursors and hydrogels are fabricated by adding a polar organic solvent to an aqueous solution of the pure conducting polymer material, followed by controlled dry-annealing to form a hydrogel precursor which can be subsequently rehydrated to form a pure conducting polymer hydrogel which comprises at least 99% of the pure conducting polymer.

### CROSS-REFERENCE TO RELATED APPLICATIONS

This application claims the benefit of U.S. Provisional Patent Application Ser. No. 62/813,097, filed Mar. 3, 2019, entitled “Pure PEDOT:PSS Hydrogels with Extraordinary Electrical, Mechanical and Swelling Properties,” which is incorporated by reference herein in its entirety.

### GOVERNMENT SUPPORT STATEMENT

This invention was made with Government support under Grant No. CMMI-1661627 awarded by the National Science Foundation. The Government has certain rights in the invention.

### FIELD OF THE INVENTION

The present invention generally relates to hydrogel precursors formed of pure conducting polymer materials, hydrogels formed therefrom, and methods of forming the hydrogel precursors and hydrogels. More particularly, the present invention relates to hydrogel precursors and hydrogels formed of pure polythiophene polymers, wherein the hydrogels are provided with a combination of properties desirable for use in biological applications.

### BACKGROUND OF THE INVENTION

Recent advances in bioelectronics are shortening the gap between electronic systems and the human body. A number of bioelectronic devices such as commercially available silicon probes, epidermal electronics, stretchable neural interfaces, and nanoscale sensor arrays have shown a great promise toward seamless merging of biology and electronics. Despite these recent successes, the majority of bioelectronic devices still rely on electrode materials which are physically and mechanically dissimilar to biological tissues. Biological tissues are typically soft (e.g., Young's moduli in the range of 1 kPa˜1 MPa) and contain large amounts of water (e.g., over 70%) with dissolved ionic species. In contrast, most inorganic materials (e.g., Si, Au, Pt, and Sn) and dry polymers (e.g., polycarbonate and polyimide) in conventional bioelectronic devices exhibit much higher elastic moduli (e.g., Young's moduli in the range of 100 MPa˜10 GPa) with virtually no water content. Hence, the search toward more tissue-like bioelectronic interface has been an ongoing challenge in the field of bioelectronics.

Among many engineering materials, hydrogels show great potential as interfacing materials to biological tissues, owing to their unique tissue-like mechanical property, water-rich nature, superior biocompatibility, and flexibility and versatility in designing their properties. However, conventional hydrogels typically lack electronic conductivity, and the ionic conductivity of hydrogels in physiological conditions is very low (e.g., 6˜9 orders of magnitude lower than the conductivity of metals).

In an attempt to address this lack of electronic conductivity in hydrogel materials, efforts have been made to utilize conducting polymers, particularly poly(3,4-ethylenedioxythiophene): poly(styrene sulfonate) (PEDOT:PSS). Existing methods to prepare PEDOT:PSS hydrogels generally rely on mixing or in situ polymerization of PEDOT:PSS within non-conductive hydrogel templates to form interpenetrating polymer networks (IPN). However, such IPN-based conducting polymer hydrogels compromise electrical conductivity and/or electrochemical performances as the non-conductive hydrogel network acts as an electrical insulator (e.g., electrical conductivity is typically below 1 S/cm in deionized water). While conductive nanofillers such as metal nanoparticles/wires, carbon nanotubes, and graphene have also been added into IPN-based PEDOT:PSS hydrogels in an effort to enhance electrical conductivity, the dispersion of nanofillers within polymer chains of hydrogel networks (typically sub-nm scale) invites potential issues such as inhomogeneity in mechanical and electrical properties as well as instability and cytotoxicity when in contact with wet biological tissues.

In a further attempt to address these challenges, pure PEDOT:PSS hydrogels have been developed by avoiding the use of non-conducting hydrogel template and/or nanofillers, but these materials are still deficient in many respects, including low electrical conductivity (<10 S cm⁻¹), low stretchability (<10% strain), high Young's moduli (>100 MPa), and/or poor stability in wet physiological environments due to the absence of a supporting matrix. While one method of increasing electrical conductivity of pure PEDOT:PSS hydrogels has been developed, this method requires the use of concentrated sulfuric acid to fabricate the hydrogel material, and the electrical conductivity is tested in an acidic solution (e.g., pH˜1), making it unsuitable for use in vivo bioelectronic applications.

Thus, further improvements in hydrogel materials and methods of making are greatly needed.

### SUMMARY OF THE INVENTION

The present invention provides hydrogel precursor materials, hydrogels, and methods of making, wherein the resulting hydrogels are provided with a combination of properties that are particularly desirable in bioelectronic applications.

According to one aspect, the present invention provides a pure conducting polymer hydrogel comprising at least about 50 wt % water, based on total weight of the pure conducting polymer hydrogel; and up to about 50 wt % of a conducting polymer component, the conducting polymer component comprising at least about 99% of one or more conducting polymers and less than about 1% of additives, crosslinkers and materials other than the one or more conducting polymers. The pure conducting polymer hydrogel has an electrical conductivity of at least about 1 S cm⁻¹ in PBS and at least about 1 S cm⁻¹ in deionized water, a stretchability of at least about 10% strain, and a Young's modulus of no greater than about 20 MPa.

Embodiments according to this aspect may include one or more of the following features. The one or more conducting polymers are selected from one or more polythiophenes. The one or more conducting polymers are selected from poly(3,4-ethylenedioxythiophene):poly(styrene sulfonate) (PEDOT:PSS), poly(3,4-ethylenedioxyselenophene) (PEDOS), poly(3,4-ethylenedithiathiophene) (PEDTT), poly(thieno[3,4-b]-1,4-oxathiane) (PEOTT), poly(N-methyl-3,4-dihydrothieno[3,4-b][1,4]oxazine) (PMDTO), poly(hydroxymethylated-3,4-ethylenedioxylthiophene) (PEDOT-MeOH), and combinations thereof. The one or more conducting polymers is poly(3,4ethylenedioxythiophene):poly(styrene sulfonate) (PEDOT:PSS). The hydrogel has an electrical conductivity of at least about 10 S cm⁻¹ in PBS and at least about 20 S cm⁻¹ in deionized water. The hydrogel has an electrical conductivity of at least about 20 S cm⁻¹ in PBS and at least about 40 S cm⁻¹ in deionized water. The hydrogel has a stretchability of at least about 20% strain. The hydrogel has a stretchability of at least about 35% strain. The hydrogel has a Young's modulus of no greater than about 10 MPa. The hydrogel has a Young's modulus of no greater than about 2 MPa. The hydrogel comprises at least about 55 wt % water and up to about 45 wt % of the conducting polymer component, based on total weight of the pure conducting polymer hydrogel. The hydrogel comprises at least about 60 wt % water and up to about 40 wt % of the conducting polymer component, based on total weight of the pure conducting polymer hydrogel. The hydrogel comprises at least about 65 wt % water and up to about 35 wt % of the conducting polymer component, based on total weight of the pure conducting polymer hydrogel. The hydrogel comprises at least about 70 wt % water and up to about 30 wt % of the conducting polymer component, based on total weight of the pure conducting polymer hydrogel. The hydrogel comprises at least about 75 wt % water and up to about 25 wt % of the conducting polymer component, based on total weight of the pure conducting polymer hydrogel. The hydrogel comprises at least about 80 wt % water and up to about 20 wt % of the conducting polymer component, based on total weight of the pure conducting polymer hydrogel. The hydrogel comprises about 80-87 wt % water and about 13-20 wt % of the conducting polymer component, based on total weight of the pure conducting polymer hydrogel.

According to another aspect, the present invention provides a pure conducting polymer hydrogel precursor comprising at least about 99% of one or more conducting polymers and less than about 1% of additives, crosslinkers and materials other than the one or more conducting polymers. Placing the hydrogel precursor in a wet environment hydrates and swells the hydrogel precursor to form a hydrogel, where the hydrogel having an electrical conductivity of at least about 1 S cm⁻¹ in PBS and at least about 1 S cm⁻¹ in deionized water, a stretchability of at least about 10% strain, and a Young's modulus of no greater than about 20 MPa.

Embodiments according to this aspect may include one or more of the following features. The hydrogel has one or more predetermined swelling properties. The one or more predetermined swelling property is anisotropic swelling. The hydrogel precursor is in the form of a film that swells in a thickness direction. The one or more predetermined swelling property is isotropic swelling. The one or more conducting polymers are selected from one or more polythiophenes. The one or more conducting polymers are selected from poly(3,4-ethylenedioxythiophene):poly(styrene sulfonate) (PEDOT:PSS), poly(3,4-ethylenedioxyselenophene) (PEDOS), poly(3,4-ethylenedithiathiophene) (PEDTT), poly(thieno[3,4-b]-1,4-oxathiane) (PEOTT), poly(N-methyl-3,4-dihydrothieno[3,4-b][1,4]oxazine) (PMDTO), poly(hydroxymethylated-3,4-ethylenedioxylthiophene) (PEDOT-MeOH), and combinations thereof. The one or more conducting polymers is poly(3,4-ethylenedioxythiophene):poly(styrene sulfonate) (PEDOT:PSS),

According to another aspect, the present invention provides a method of fabricating a pure conducting polymer hydrogel precursor comprising mixing one or more conducting polymers with a first solvent to form an aqueous solution, adding one or more polar organic solvent to the aqueous solution, and performing dry-annealing to form the hydrogel precursor, where the pure conducting polymer hydrogel precursor comprises at least about 99% of one or more conducting polymers and less than about 1% of additives, crosslinkers and materials other than the one or more conducting polymers.

Embodiments according to this aspect may include one or more of the following features. The one or more conducting polymers are selected from one or more polythiophenes. The one or more conducting polymers are selected from poly(3,4-ethylenedioxythiophene):poly(styrene sulfonate) (PEDOT:PSS), poly(3,4-ethylenedioxyselenophene) (PEDOS), poly(3,4-ethylenedithiathiophene) (PEDTT), poly(thieno[3,4-b]-1,4-oxathiane) (PEOTT), poly(N-methyl-3,4-dihydrothieno[3,4-b][1,4]oxazine) (PMDTO), poly(hydroxymethylated-3,4-ethylenedioxylthiophene) (PEDOT-MeOH), and combinations thereof. The one or more conducting polymers is poly(3,4-ethylenedioxythiophene):poly(styrene sulfonate) (PEDOT:PSS). The one or more polar organic solvent is selected from dimethyl sulfoxide (DMSO), ethylene glycol (EG), xylene, methanol, dimethylformamide (DMF), tetrahydrofuran (THF), and combinations thereof. Dry-annealing is performed to provide one or more tunable swelling properties of the hydrogel precursor in wet physiological environments. The dry-annealing is performed under mechanically constrained conditions to form a hydrogel precursor, wherein the hydrogel precursor isotropically swells to form a hydrogel in a wet environment. The dry-annealing is performed under mechanically unconstrained conditions to form a hydrogel precursor, wherein the hydrogel precursor anisotropically swells to form a hydrogel in a wet environment.

According to another aspect, the present invention provides a method of fabricating a pure conducting polymer hydrogel comprising mixing one or more conducting polymers with a first solvent to form an aqueous solution; adding one or more polar organic solvent to the aqueous solution; and performing dry-annealing to form a hydrogel precursor, the hydrogel precursor comprising at least about 99% of one or more conducting polymers and less than about 1% of additives, crosslinkers and materials other than the one or more conducting polymers; and rehydrating the hydrogel precursor to form the pure conducting polymer hydrogel. The hydrogel has an electrical conductivity of at least about 1 S cm⁻¹ in PBS and at least about 1 S cm⁻¹ in deionized water, a stretchability of at least about 10% strain, and a Young's modulus of no greater than about 20 MPa.

Embodiments according to this aspect may include one or more of the following features. The one or more conducting polymers are selected from one or more polythiophenes. The one or more conducting polymers are selected from poly(3,4-ethylenedioxythiophene):poly(styrene sulfonate) (PEDOT:PSS), poly(3,4-ethylenedioxyselenophene) (PEDOS), poly(3,4-ethylenedithiathiophene) (PEDTT), poly(thieno[3,4-b]-1,4-oxathiane) (PEOTT), poly(N-methyl-3,4-dihydrothieno[3,4-b][1,4]oxazine) (PMDTO), poly(hydroxymethylated-3,4-ethylenedioxylthiophene) (PEDOT-MeOH), and combinations thereof. The one or more conducting polymers is poly(3,4-ethylenedioxythiophene):poly(styrene sulfonate) (PEDOT:PSS). The one or more polar organic solvent is selected from dimethyl sulfoxide (DMSO), ethylene glycol (EG), xylene, methanol, dimethylformamide (DMF), tetrahydrofuran (THF), and combinations thereof. Dry-annealing is performed to provide one or more tunable swelling properties of the hydrogel precursor in wet physiological environments. Dry-annealing is performed under mechanically constrained conditions to form a hydrogel precursor, wherein the hydrogel precursor isotropically swells to form a hydrogel in a wet environment. Dry-annealing is performed under mechanically unconstrained conditions to form a hydrogel precursor, wherein the hydrogel precursor anisotropically swells to form a hydrogel in a wet environment.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principals of the invention.

FIGS. 1A-C schematically illustrate the preparation of a pure PEDOT:PSS hydrogel according to an embodiment of the present invention, wherein FIG. 1A illustrates the chemical structures of PEDOT, PSS, and DMSO, FIG. 1B illustrates a typical drying and swelling processes of pristine PEDOT:PSS without DMSO, FIG. 1C illustrates a dry-annealing and swelling processes of PEDOT:PSS with DMSO additive in accordance with an embodiment of the present invention.

FIG. 2 illustrates the dissociation of a conventional pristine PEDOT:PSS in a wet environment, wherein a dried pristine PEDOT:PSS microball swells and readily dissociates into fragmented microgels instead of forming a stable hydrogel.

FIGS. 3A-J illustrate the dry-annealing and swelling behaviors of pure PEDOT:PSS hydrogels according to embodiments of the present invention, wherein FIG. 3A schematically illustrates isotropic dry-annealing of a PEDOT:PSS aqueous solution into a microball, FIG. 3B schematically illustrates anisotropic dry-annealing of a PEDOT:PSS aqueous solution into a free-standing film, FIG. 3C shows experimental images for isotropic dry-annealing of a PEDOT:PSS aqueous solution into a microball, FIG. 3D shows experimental images for anisotropic dry annealing of a PEDOT:PSS aqueous solution into a free-standing film, FIG. 3E shows isotropic swelling of a pure dry-annealed PEDOT:PSS microball into a stable hydrogel, FIG. 3F shows anisotropic swelling of a freestanding pure dry-annealed PEDOT:PSS film into a stable hydrogel, FIGS. 3G-H graphically depict dimensional changes vs. time during the (G) isotropic and (H) anisotropic dry-annealing of PEDOT:PSS aqueous solution. FIGS. 3I-J graphically depict dimensional changes vs. time during the (I) isotropic and (J) anisotropic swelling of pure PEDOT:PSS hydrogels, where values in FIGS. 3G-J represent mean and the error bars represent the standard deviation of the measured values (n=3).

FIG. 4 graphically depicts the FT-IR spectra of various PEDOT:PSS solutions, including dry-annealed and swollen pure PEDOT:PSS hydrogels according to embodiments of the present invention, where the PEDOT:PSS aqueous solutions with varying DMOS concentrations (0, 5, and 20 vol. %) display characteristic absorption peaks for DMSO (1,024 cm−1 for stretching vibration of sulfoxyl group; 950 cm−1 for bending and 3,000 and 2,910 cm−1 for stretching vibration of methyl group), while these peaks for DMSO disappear for the present invention dry-annealed and swollen pure PEDOT:PSS hydrogels.

FIG. 5 illustrates the long-term stability of a pure PEDOT:PSS hydrogel according to an embodiment of the present invention in a wet physiological environment, wherein the pure PEDOT:PSS hydrogel prepared from a PEDOT:PSS aqueous solution with 13 vol. % DMSO shows extraordinary stability in PBS over 3 months without any visible degradation or dissociation.

FIG. 6 graphically illustrates the swelling ratio vs. DMSO concentration of pure PEDOT:PSS hydrogels in wet environments based on varying DMSO concentrations both in PBS and in deionized water, wherein values represent mean and the error bars represent the standard deviation of measured values (n=3).

FIG. 7 shows AFM phase images of dry-annealed PEDOT:PSS free-standing films, with FIG. 7A showing a pristine PEDOT:PSS film prepared without DMSO and FIGS. 7B-F showing dry-annealed pure PEDOT:PSS films prepared by adding different amounts of DMSO according to embodiments of the present invention: (b) 5 vol. % DMSO, (c) 13 vol. % DMSO, (d) 20 vol. % DMSO, (e) 33 vol. % DMSO, and (f) 50 vol. % DMSO, where that vol. % indicates the volume fraction of the added DMSO to the final solution volume, with the measured surface roughness for each film being (a) 1.6 nm, (b) 1.4 nm, (c) 2.5 nm, (d) 2.0 nm, (e) 2.1 nm, and (f) 3.1 nm.

FIG. 8 graphically illustrates WAXS profiles of dry-annealed and swollen pure PEDOT:PSS hydrogels, where the WAXS profiles are dry-annealed pure PEDOT:PSS films based on varying DMSO concentrations (0, 5, and 20 vol. %), and where the profiles are shifted vertically for clarity.

FIGS. 9A-F graphically illustrate mechanical and electrical characterizations of pure PEDOT:PSS hydrogels according to embodiments of the present invention, with FIG. 9A showing nominal stress vs. strain curves of free-standing pure PEDOT:PSS hydrogels in PBS with varying DMSO concentrations, FIG. 9B showing Young's moduli and ultimate tensile strains vs. DMSO concentration for pure PEDOT:PSS hydrogels in PBS, FIG. 3C showing the electrical conductivity of pure PEDOT:PSS hydrogels in deionized water and in PBS with varying DMSO concentrations, FIG. 9D showing the electrical conductivity of pure PEDOT:PSS hydrogels at different strain in deionized water and in PBS, FIG. 9E showing CV curves for pure PEDOT:PSS hydrogel on Pt electrode in PBS, with the center dashed curve representing the CV curve of bare Pt electrode as control, and FIG. 9F showing the cyclic electrochemical current pulse injection curves of the pure PEDOT:PSS hydrogel on Pt electrode between −1.5 V and 1.5 V vs. Ag/AgCl.

FIGS. 10A-B graphically illustrate the mechanical characterizations of pure PEDOT:PSS hydrogels according to embodiments of the present invention in deionized water, with FIG. 10A showing the nominal stress vs. strain curves of pure PEDOT:PSS hydrogels in deionized water based on varying DMSO concentrations, and FIG. 10B showing Young's moduli and ultimate tensile strains vs. DMSO concentration for pure PEDOT:PSS hydrogels in deionized water. Values in FIG. 10B represent mean and the error bars represent the standard deviation of measured values (n=4).

FIG. 11 shows the tensile deformation of pure PEDOT:PSS hydrogel according to an embodiment of the present invention in PBS, where the pure PEDOT:PSS hydrogel exhibits good stretchability and sustains tensile deformation over 35% in s wet physiological environment without failure.

FIG. 12 graphically illustrates the cyclic tensile deformations of pure PEDOT:PSS hydrogel according to an embodiment of the present invention in PBS, where a pure PEDOT:PSS hydrogels based on 13 vol. % DMSO concentration exhibits moderate level of plastic deformation during cyclic tensile deformation from 5% to 30%.

FIG. 13 graphically illustrates electrical conductivity of pure PEDOT:PSS hydrogels according to an embodiments of the present invention in acidic PBS, where the pH of PBS is adjusted to 1 by adding HCl, and where values represent mean and the error bars represent the standard deviation of measured values (n=3).

FIGS. 14A-C graphically illustrate electrical and electrochemical stability of pure PEDOT:PSS hydrogels according to an embodiment of the present invention in wet environment, where FIG. 14A demonstrates electrical conductivity of pure PEDOT:PSS hydrogels exhibits good stability both in PBS and deionized water over 3 months, FIG. 14B demonstrates CSC of pure PEDOT:PSS hydrogel shows good stability in PBS with less than 9% change after 20,000 cycles, and FIG. 14D demonstrates CIC of pure PEDOT:PSS hydrogel shows good stability in PBS with less than 10% change after 20,000 cycles, and where values in FIG. 14A represent mean and the error bars represent the standard deviation of measured values (n=3).

FIGS. 15A-D graphically illustrate electrical conductivity of pure PEDOT:PSS hydrogels at different strains according to embodiments of the present invention in deionized water, where the electrical conductivity of pure PEDOT:PSS hydrogels are measured at different tensile strains in deionized water based on 5 vol. % DMSO (FIG. 15A), 9 vol. % DMSO (FIG. 15B), 33 vol. % DMSO (FIG. 15C), and 50 vol. % DMSO (FIG. 15D), and where values in FIGS, 15A-D represent mean and the error bars represent the standard deviation of measured values (n=3).

FIGS. 16A-D graphically depict the electrical conductivity of pure PEDOT:PSS hydrogels at different strains according to embodiments of the present invention in PBS, where electrical conductivity of pure PEDOT:PSS hydrogels is measured at different tensile strains in PBS based on 5 vol. % DMSO (FIG. 16A), 9 vol. % DMSO (FIG. 16B), 33 vol. % DMSO (FIG. 16C), and 50 vol. % DMSO (FIG. 16D), and where values represent mean and the error bars represent the standard deviation of measured values (n=3).

FIGS. 17A-C illustrates the patterning of pure PEDOT:PSS hydrogels according to embodiments of the present invention, where FIG. 17A (a) shows patterned PEDOT:PSS ink on PET substrate, FIG. 17B shows experimental images of anisotropic drying process of the patterned ink over time, FIG. 17C illustrates that a free-standing pure PEDOT:PSS hydrogel pattern can be fabricated by peeling the dry-annealed pattern and swelling in PBS, and FIG. 17C illustrates an embodiment where a robust laminate of pure PEDOT:PSS hydrogel pattern is fabricated by suppressing delamination via anisotropic swelling behavior.

### DETAILED DESCRIPTION

The following definitions are useful for interpreting terms applied to features of the embodiments disclosed herein, and are meant only to define elements within the disclosure.

As used herein, the term “pure”, when describing the conducting polymer materials in the hydrogel precursors and hydrogels, refers to the material whose constituent composition is made out of conducting polymers with less than 1% of other materials including additives or crosslinkers.

As used herein, the term “hydrogel precursor” refers to the conducting polymer material prior to rehydration, wherein rehydration of the hydrogel precursor results in the formation of a hydrogel without any further processing steps. For example, placement of the hydrogel precursor in a wet environment and/or contacting the hydrogel precursor with one or more suitable fluids results in the hydrogel precursor absorbing the one or more fluids and becoming a hydrogel. Generally, the hydrogel precursor is the resulting material formed upon dry-annealing. As the dry-annealed pure conducting polymer (hydrogel precursor) is hydrophilic, it can absorb various aqueous fluids to become a hydrogel including but not limited to 1) aqueous electrolytes, which are particularly suitable for energy or device applications, 2) body fluids, such as saliva, blood, interstitial fluids, cerebrospinal fluids, gastric fluids, etc., and 3) commonly-used aqueous solutions, such as deionized water, cell culture media such as phosphate buffered saline (PBS), Dulbecco's modified eager medium (DMEM), etc.

As used herein, the term “conducting polymer” refers to conjugated polymers that have intrinsic electrical conductivity.

As used herein, the term “high electrical conductivity”, when describing the hydrogel, refers to an electrical conductivity of at least about 1 S cm⁻¹, more preferably at least about 5 S cm⁻¹, more preferably at least about 10 S cm⁻¹, more preferably at least about 15 S cm⁻¹, more preferably at least about 20 S cm⁻¹ when measured in PBS, and at least about 1 S cm⁻¹, more preferably at least about 5 S cm⁻¹, more preferably at least about 10 S cm⁻¹, more preferably at least about 15 S cm⁻¹, more preferably at least about 20 S cm⁻¹ more preferably at least about 25 S cm⁻¹, more preferably at least about 30 S cm⁻¹, more preferably at least about 35 S cm⁻¹, more preferably at least about 40 S cm⁻¹ when measured in deionized water.

As used herein, the term “high stretchability”, when describing the hydrogel, refers to the amount of tensile deformation relative to the original dimension that the material can withstand before failure or fracture of the material, and is at least about 10% strain, more preferably at least about 15% strain, more preferably at least about 20% strain, more preferably at least about 25% strain, more preferably at least about 30% strain, more preferably at least about 35% strain.

As used herein, the term “low Young's modulus”, when describing the hydrogel, refers to a value of no greater than about 20 MPa, more preferably no greater than about 15 MPa, more preferably no greater than about 10 MPa, more preferably no greater than about 5 MPa, more preferably no greater than about 2 MPa.

As used herein, the term “superior mechanical stability”, when describing the hydrogel, refers to the capability to maintain mechanical properties including structural integrity, stretchability, Young's modulus in aqueous environments over 1 month period. Such capability to maintain mechanical properties includes no greater than a 20% change from the original mechanical property value at the start of the 1 month period.

As used herein, the term “superior electrical stability” when describing the hydrogel, refers to the capability to maintain electrical properties including electrical conductivity in aqueous environment over 1 month period. Such capability to maintain electrical properties includes no greater than a 20% change from the original electrical property value at the start of the 1 month period.

As used herein, the term “superior electrochemical stability”, when describing the hydrogel, refers to the capability to maintain electrochemical activity including charge injection capability and redox stability over 1,000 charging and discharging cycles. Such capability to maintain electrochemical activity includes no greater than a 20% change from the original electrochemical activity value at the start of the 1,000 charging and discharging cycles.

As used herein, the term “tunable swelling behaviors” in wet physiological environment refers to the ability to form a hydrogel having pre-determined swelling characteristics, particularly having either isotropic or anisotropic swelling characteristics.

As used herein, the term “body fluid” refers to aqueous physiological fluids including blood, saliva, gastrointestinal fluid, mucus, and succus.

As used herein, the term “absorb”, when describing the mechanism by which the hydrogel precursor absorbs fluid and ions, refers to atoms or molecules from the fluid crossing the surface of and entering the hydrogel precursor.

As used herein, the term “film”, when describing one form in which the hydrogel precursors and hydrogels may be provided, refers to a structure in which a thickness of the hydrogel is much less than a length of the hydrogel. In particular, the thickness of such a film structure would be no more than about 10% of the length of the hydrogel.

As used herein, the term “mircoball”, when describing one form in which the hydrogel precursors and hydrogels may be provided, refers to a generally spherical structure in which the generally spherical structure has a diameter in the micron range. In particular, the diameter of such a microball structure would be no greater than about 1,000 μm, more preferably no greater than about 900 μm, more preferably no greater than about 800 μm, more preferably no greater than about 700 μm, more preferably no greater than about 600 μm, more preferably no greater than about 500 μm, and in some embodiments ranges from about 100 μm to about 500 μm.

As used herein, the term “wet physiological condition”, when describing an environment that the hydrogel is introduced to (particularly for testing purposes) refers to an aqueous medium with similar salinity, temperature, and pH to body fluids such as physiological saline or phosphate buffered saline (PBS).

As used herein, the term “wet environment” when used to refer to placing the hydrogel precursor in a wet environment to rehydrate/swell the hydrogel precursor to form a hydrogel, includes placing the hydrogel precursor in any environment in which one or more suitable fluids in the environment will be absorbed by the hydrogel precursor to form the hydrogel having the water content described herein. Such placement in a wet environment includes placing the hydrogel precursor in vivo where the hydrogel precursor absorbs bodily fluids, placing the hydrogel precursor in a suitably humid environment where the hydrogel precursor absorbs fluids from the humid environment, or depositing one or more suitable fluids on the hydrogel precursor (e.g., using a dropper or the like to deposit fluids onto the hydrogel precursor).

The present invention generally provides hydrogel precursors and hydrogels that are formed of a pure conducting polymer material, wherein the hydrogels exhibit a combination of properties inaccessible in previous materials. More particularly, the hydrogels are provided with a combination of desirable properties, including high electrical conductivity (e.g., ˜20 S cm⁻¹ in PBS, ˜40 S cm⁻¹ in deionized water), high stretchability (e.g., >35% strain), low Young's modulus e.g., (˜2 MPa), superior mechanical, electrical and electrochemical stability, and tunable swelling behaviors in wet physiological environments. The present invention not only addresses a long-lasting challenge in the development of high performance conducting polymer hydrogels, but also offers a promising material for several applications including: (1) electrodes and electronic interface for implantable devices (stimulation, recording, and sensing devices) due to their tissue-like mechanical property while having good electrical properties, (2) electrodes for energy storage devices (supercapacitor, thermoelectric devices) due to their high capacitance and stability in solvent-rich environments, and (3) electrodes for wearable devices (flexible sensors and circuits) due to their mechanical flexibility and stretchability while maintaining good electrical properties.

The present invention further provides a simple yet effective method to achieve pure conducting polymer hydrogel precursors and hydrogels. In particular, the method generally includes adding a polar organic solvent to an aqueous solution of the conducting polymer material, followed by controlled dry-annealing to form a hydrogel precursor. The hydrogel precursor can subsequently be rehydrated to form the pure conducting polymer hydrogel. Unlike conventional hydrogels, the present invention conducting polymer hydrogels offer both electronic and ionic conductivity, rendering them as one of the most promising materials in the emerging field of hydrogel bioelectronics.

According to embodiments of the present invention, the conducting polymer is selected from any conducting polymer(s) in the PEDOT family, generally referred to as polythiophenes. One preferred conducting polymer for use in the present invention is poly(3,4-ethylenedioxythiophene):poly(styrene sulfonate) (PEDOT:PSS). In addition to PEDOT:PSS, other conventional PEDOT analogs and derivatives that are compatible with the present invention include, but not limited to, poly(3,4-ethylenedioxyselenophene) (PEDOS), poly(3,4-ethylenedithiathiophene) (PEDTT), poly(thieno[3,4-b]-1,4-oxathiane) (PEOTT), poly(N-methyl-3,4-dihydrothieno[3,4-b][1,4]oxazine) (PMDTO), poly(hydroxymethylated-3,4-ethylenedioxylthiophene) (PEDOT-MeOH), and combinations thereof.

The hydrogels of the present invention are prepared so as to produce pure conducting polymer (e.g. PEDOT:PSS) hydrogels with extraordinary electrical, mechanical, and swelling properties without blending other polymers into the material. In particular, an aqueous solution of the conducting polymer material is first formed, followed by adding a suitable amount of polar organic solvent to the aqueous solution. Suitable polar organic solvents are generally volatile polar organic solvents and include, but are not limited to, dimethyl sulfoxide (DMSO), ethylene glycol (EG), xylene, methanol, dimethylformamide (DMF), tetrahydrofuran (THF), and combinations thereof.

According to an embodiment of the present invention, DMSO is added into PEDOT:PSS aqueous solutions followed by controlled dry-annealing and subsequent rehydration to yield pure PEDOT:PSS hydrogels, wherein the electrical, mechanical and swelling properties are systematically tunable by varying the amount of added DMSO and by varying the dry-annealing specifications. For example, the number of cycles of dry-annealing, the time of each cycle and the temperature at which dry-annealing is conducted can be adjusted to modify the properties of the resulting hydrogel. According to embodiments of the present invention at least 1 cycle of dry-annealing is carried out at a temperature high enough to sufficiently remove the one or more solvents (e.g., water and volatile additives). In some embodiments, additional cycles are carried out and/or a higher temperature is used. However, additional cycles and higher temperatures do not always correlate to better performance or properties. In particular, one or more of the material properties may show saturation beyond a certain optimal level of structural evolution by dry-annealing in high temperature when the material becomes the pure conducting polymer (i.e., hydrogel precursor). In general, more than 1 cycle of dry-annealing is carried out and the temperature is higher than boiling point of water (100° C.) but lower than the polymer thermal degradation point (which will generally be about 200° C. for all conducting polymers of the present invention).

Thermal degradation point is similar for most of organic electronic materials not only for PEDOT:PSS. Most of organic conducting polymers start to degrade at temperature over 200 C due to chain deterioration or carbonization.

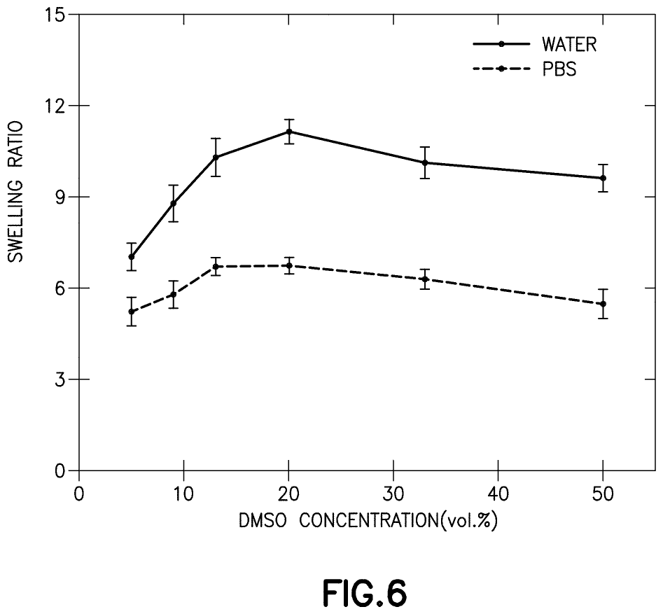

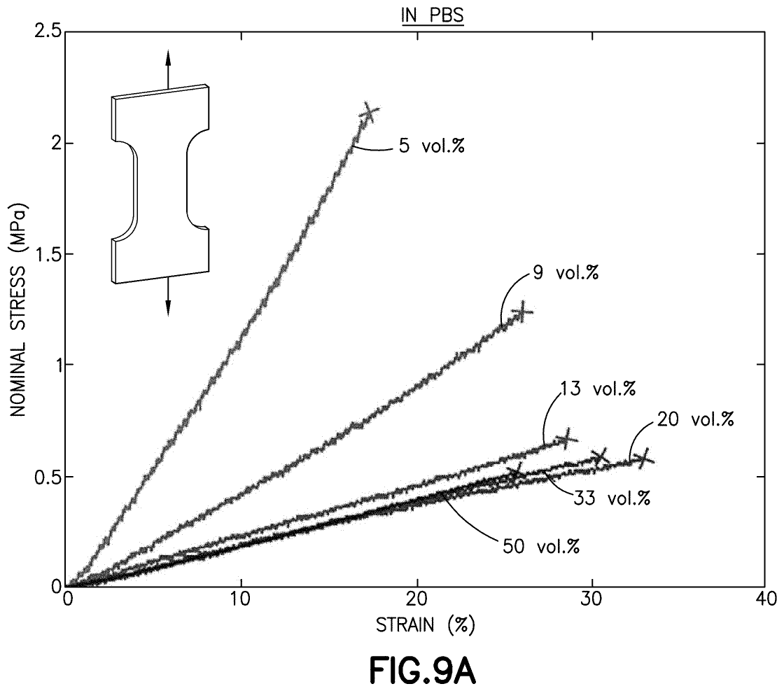

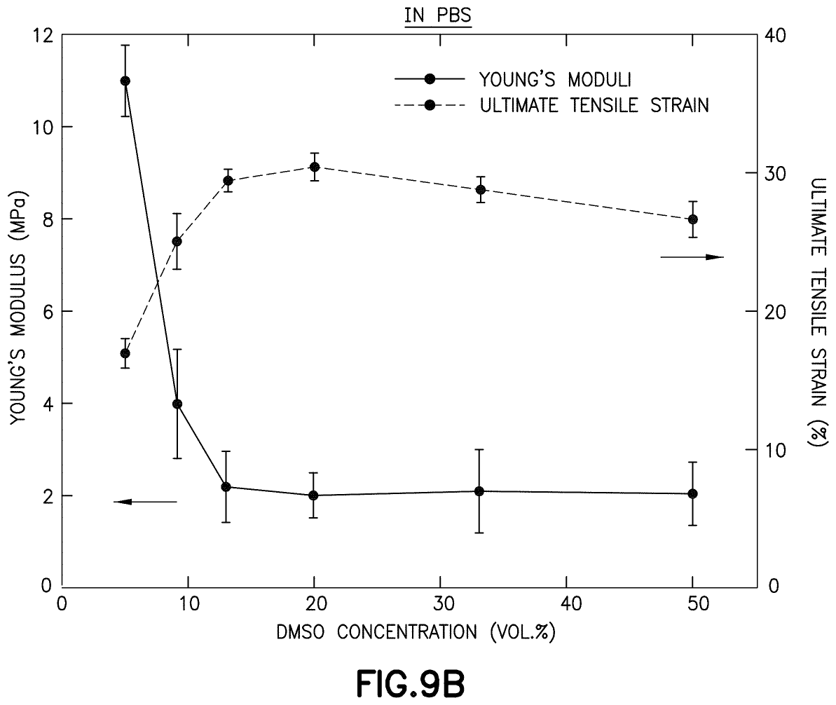

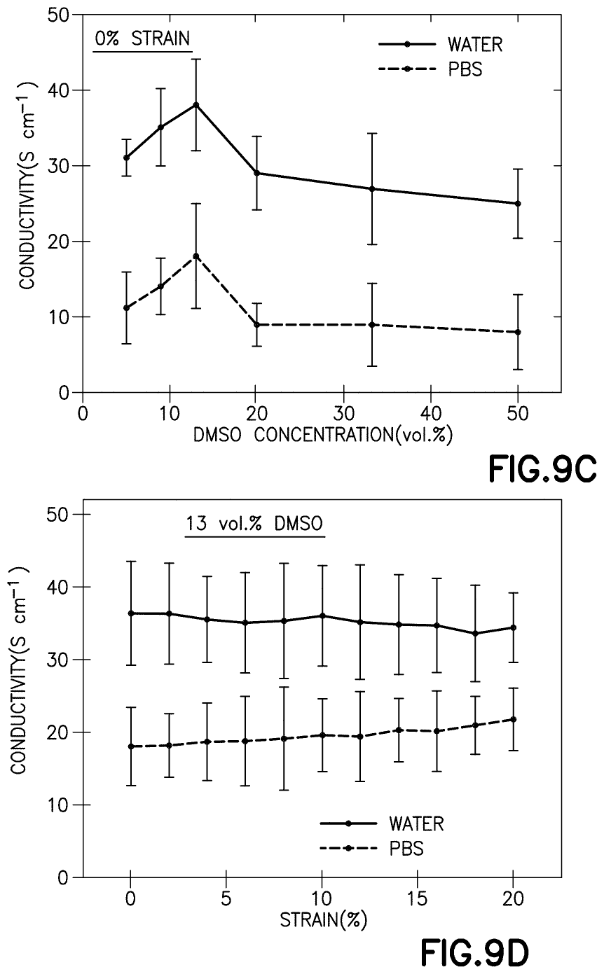

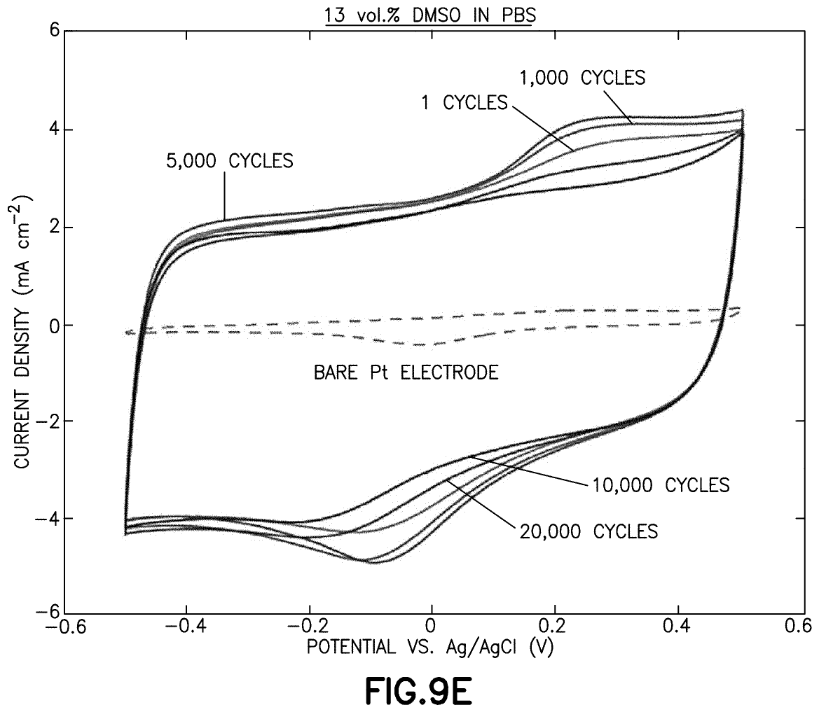

Further, as shown in FIG. 6, the swelling ratio of the produced hydrogel in both water and PBS can be adjusted based on the polar organic solvent (DMSO) concentration. In addition, nominal stress vs. strain, Young's modulus, and conductivity of the hydrogel are all tunable by adjusting the polar organic solvent (DMSO) concentration as demonstrated in FIGS. 9A-C, 10A-B, 13, 15A-D and 16A-D.

According to a preferred embodiment, the hydrogel is a pure PEDOT:PSS hydrogel that is formed by added 13 vol % DMSO and dry-annealing for 3 cycles of 30 min annealing at 130° C. The polar organic solvent vol. % indicates the volume fraction of the added polar organic solvent to the final solution volume. The resulting pure PEDOT:PSS hydrogel was provided with superior electrical conductivity of ˜20 S cm⁻¹ in phosphate buffered saline (PBS) and ˜40 S cm⁻¹ in deionized water, as well as low Young's modulus of ˜2 MPa and high stretchability of over 35% strain in wet physiological environments—a set of properties inaccessible in previous PEDOT:PSS hydrogels yet highly desirable for bioelectronic applications. The resultant pure PEDOT:PSS hydrogels exhibit remarkably long-term mechanical stability in wet physiological conditions, with no observable damage such as tearing or crack under microscopic imaging over 3 months storage in PBS bath at 37 C with gentle shaking (100 rpm). The hydrogel further demonstrated electrical stability in wet physiological conditions, with change in electrical conductivity less than 10% of the original value over 3 months. The hydrogel also possessed electrochemical stability in wet physiological conditions, demonstrating less than 10% change in charge storage capability and charge injection capacity values after 20,000 charging and discharging cycles in wet physiological conditions.

According to further embodiments of the present invention, by dry-annealing the conducting polymer/polar organic solvent solution under either (a) mechanically constrained or (b) mechanically unconstrained conditions, a hydrogel can be produced that either swells (a) isotropically or (b) anisotropically, respectively. In other words, using isotropic dry-annealing of the conducting polymer/polar organic solvent aqueous solution leads to isotropic swelling of the stable pure PEDOT:PSS hydrogel. On the other hand, using anisotropic dry-annealing provides anisotropic swelling in out-of-plane or thickness direction. As such, the present method provides for tunable swelling behaviors which are compatible to various fabrication approaches, and which can provide more tailored hydrogel materials specific to the desired end use.

The present invention further provides highly conductive, stretchable and stable pure conducting polymer hydrogels and methods of formation, wherein the resulting hydrogel can be provided in free-standing and robust laminate forms with complex patterns.

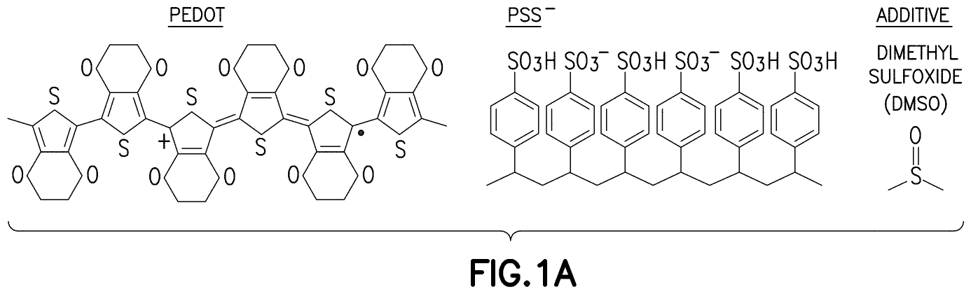

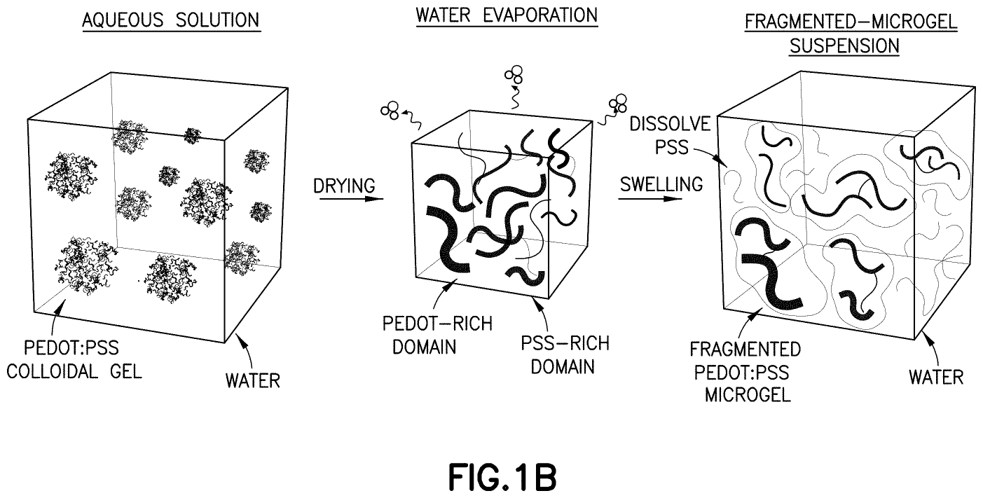

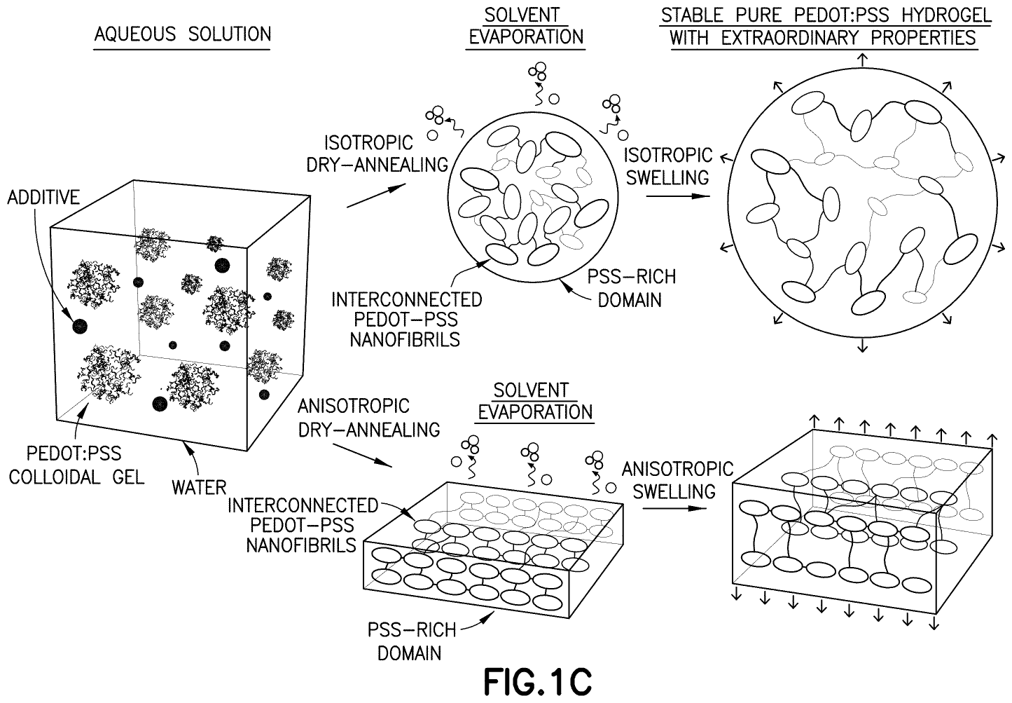

According to an embodiment of the present invention, and as schematically depicted in FIGS. 1A-C, a pure PEDOT:PSS hydrogel is fabricated by the methods described herein and using DMSO as the polar organic solvent. Stable water dispersion of PEDOT is generally achieved by introducing anionic polymers, such as poly(styrene sulfonic acid) (PSS), which serves as a charge-balancing counter ion template, as depicted in the chemical structures of PEDOT and PSS in FIG. 1A. As shown in FIG. 1B, in the absence of a polar organic solvent such as DMSO, aqueous colloidal dispersion solution PEDOT:PSS tends to form micellar microstructures that consist of a hydrophobic PEDOT-rich core and hydrophilic PSS-rich shell. There are three major molecular interactions in PEDOT:PSS: (i) electrostatic forces of attraction between π conjugated PEDOT chains and negative charged PSS chains, (ii) π-π stacking of adjacent PEDOT chains, and (iii) interchain entanglements mostly between long PSS chains. According to the present invention, in order to form a pure PEDOT:PSS hydrogel with high electrical conductivity, these molecular interactions are tamed appropriately to achieve a water-stable network of rigid hydrophobic PEDOT-rich semi-crystalline domains and soft hydrophilic PSS-rich matrix.

One approach of the present invention to provide pure conducting polymer (e.g., PEDOT:PSS) hydrogels is to dry-anneal the PEDOT:PSS aqueous solution in a controlled manner, and then reswell/rehydrate the dry-annealed PEDOT:PSS into a hydrogel. According to the present method, the loss of water in the aqueous conducting polymer solution during the drying process concentrates PEDOT:PSS, and the subsequent annealing in an elevated temperature enables recrystallization of PEDOT-rich domains and chain rearrangement for both PEDOT and PSS. Without being bound by theory, it is believed that the resultant dry PEDOT:PSS likely undergoes phase separation into three different domains: (i) rigid conjugated PEDOT-rich crystalline region, (ii) disordered PEDOT:PSS semi-crystalline region, and (iii) PSS-rich soft region. By controlling these three domains into a well-distributed network, a stable and highly conductive PEDOT:PSS hydrogel can be achieved by swelling the hydrophilic PSS-rich domains while maintaining the percolated network of PEDOT-rich domains (see FIG. 1C). As such, a high boiling point polar co-solvent, such as dimethyl sulfoxide (DMSO), is added to the PEDOT:PSS solution to facilitate the recrystallization of PEDOT and chain rearrangement of PEDOT:PSS during the dry-annealing process. Notably, both solvents (i.e., water and DMSO) are completely removed by thorough evaporation during the drying (e.g., 24 h at 60° C.) and the subsequent high-temperature annealing processes (e.g., 3 cycles of 30 min annealing at 130° C.), yielding pure PEDOT:PSS hydrogels as the final product.

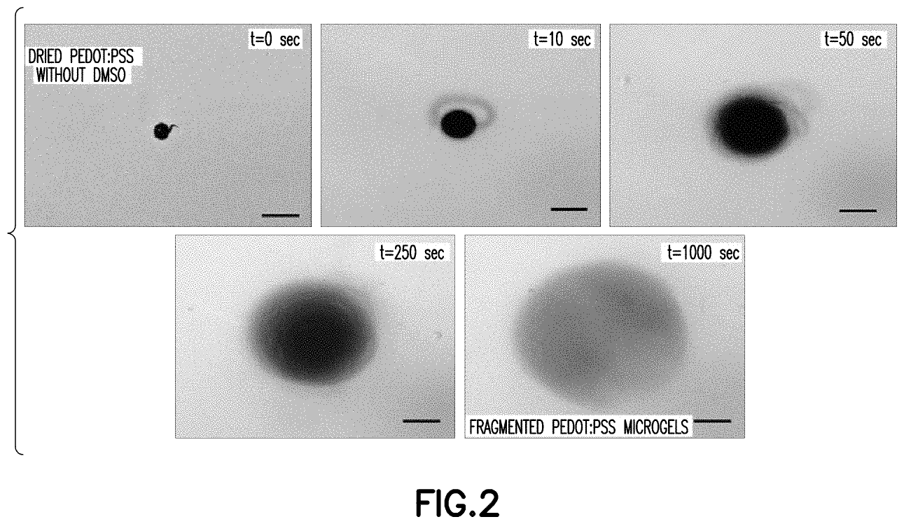

As described, the present invention pure conducting polymer hydrogels are provided with excellent mechanical stability. In order to test the mechanical stability, hydrogels of the present invention were compared with hydrogels formed of pristine PEDOT:PSS without use of a polar organic solvent (FIG. 1B). The pristine PEDOD:PSS solution was first dried without any additive/solvent in the aqueous condition. The resultant pristine PEDOT:PSS dissociates easily into fragmented microgels in a wet environment due to the absence of the percolated PEDOT-rich domains (which maintain mechanical integrity during the swelling process according to the present invention) (see FIG. 2). The demonstrated instability of the pristine PEDOT:PSS in wet environment is consistent with the previous reports on dissolution of the PEDOT:PSS electrodes in aqueous media.

On the other hand, it was found that strong polar co-solvents, such as DMSO, increase the electrical conductivity of conductive polymers, such as PEDOT:PSS, by secondary doping (e.g., electrical conductivity increase from ˜0.1 to over 10³ S cm⁻¹) In particular, the use of strong polar-co-solvents effectively extends the PEDOT:PSS microgel particles from a trapped and/or folded state into linear long chains (particularly during the first stage of dry-annealing, as depicted in FIG. 1C), and therefore, facilitates the formation of a larger crystalline PEDOT domain and the inter-chain entanglements between PSS chains during the dry-annealing process as depicted in FIG. 1C. As further shown in FIG. 1C, isotropic dry-annealing of the pure conducting polymer (e.g., PEDOT:PSS) aqueous solution with polar organic solvent (e.g., DMSO) leads to isotropic swelling of the stable pure conducting hydrogel, while anisotropic dry-annealing provides anisotropic swelling in the out-of-plane or thickness direction.

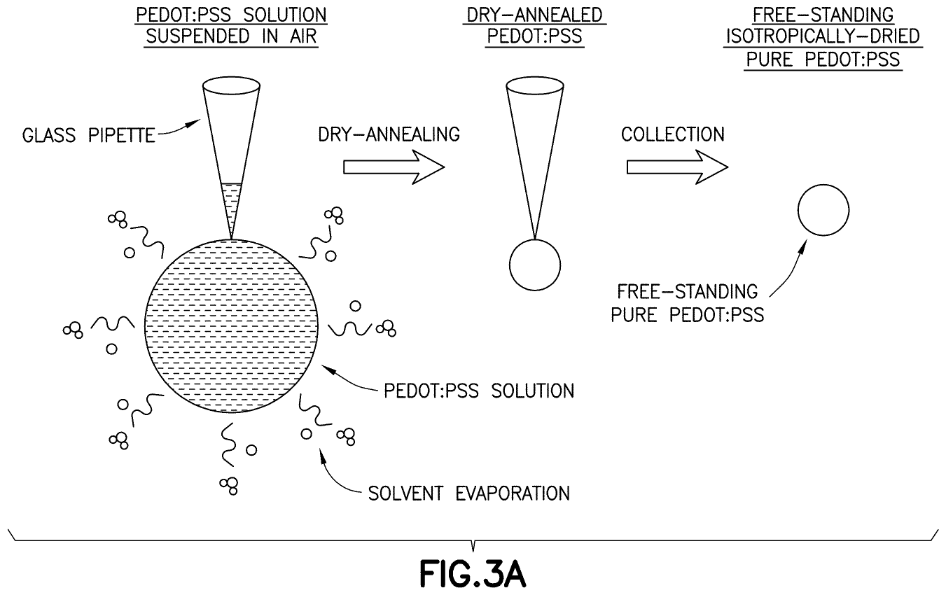

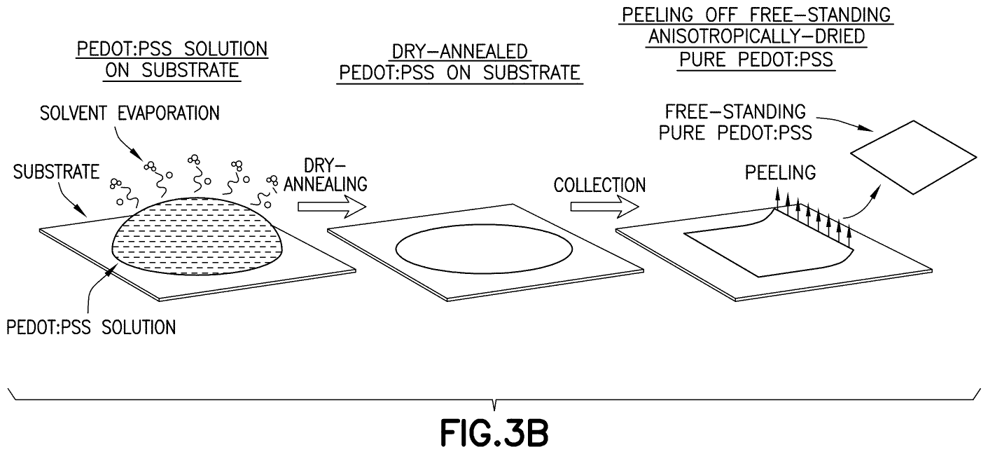

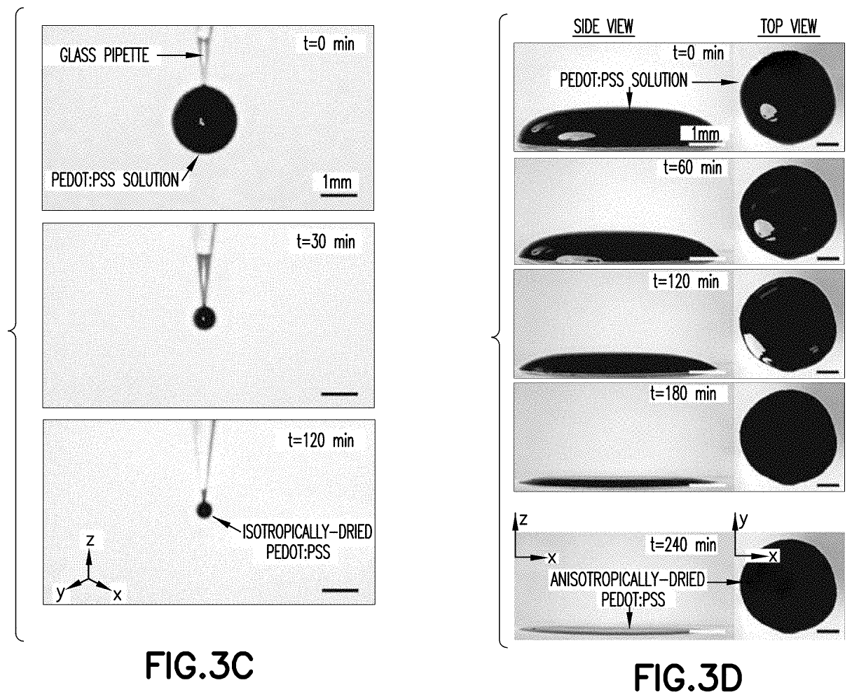

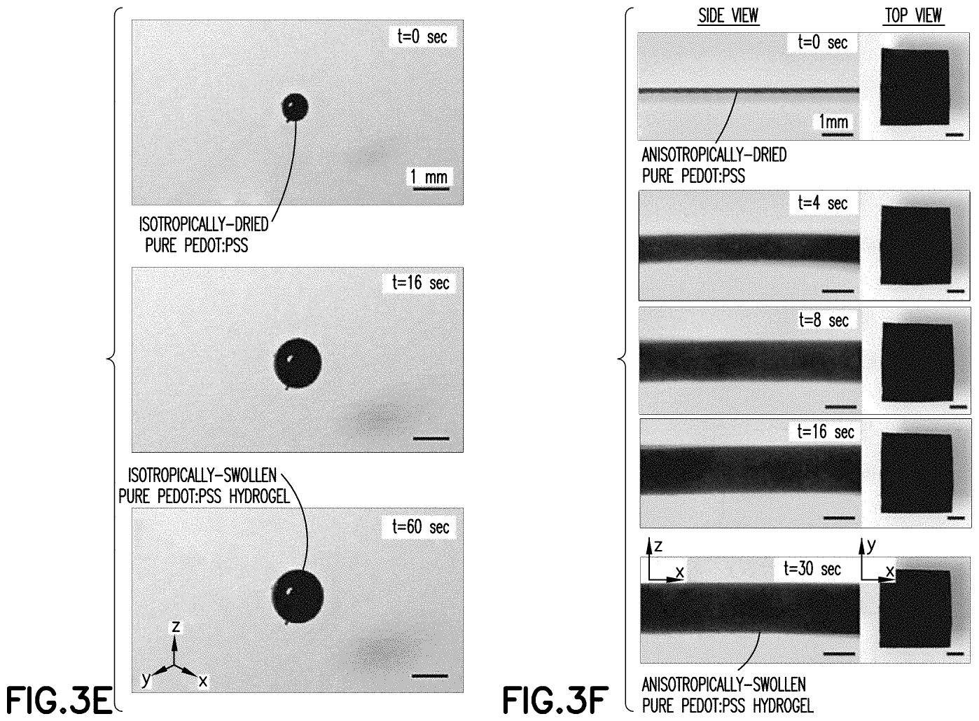

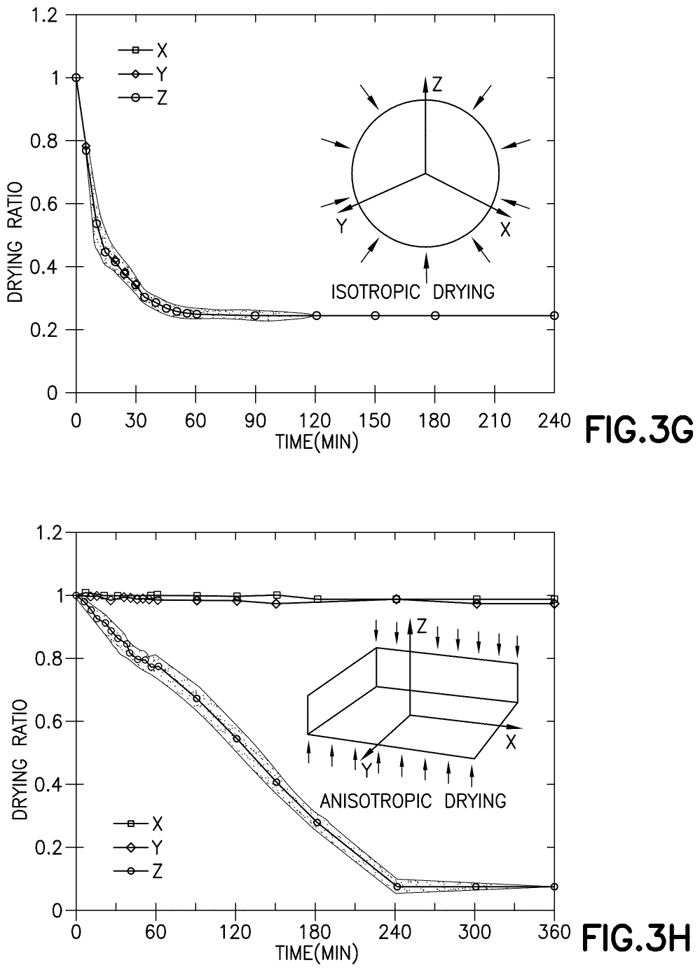

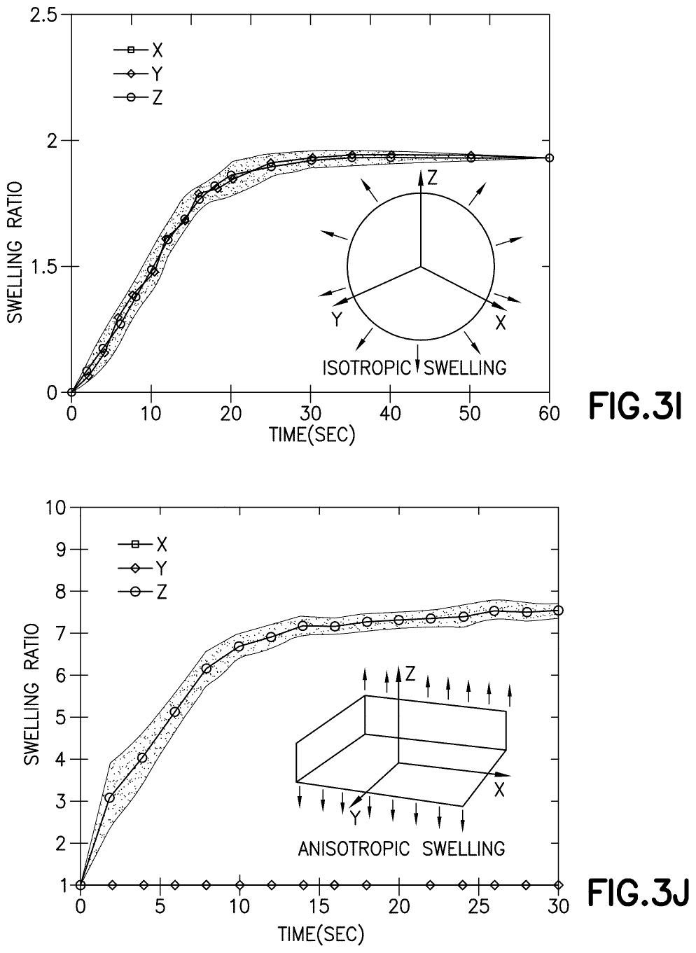

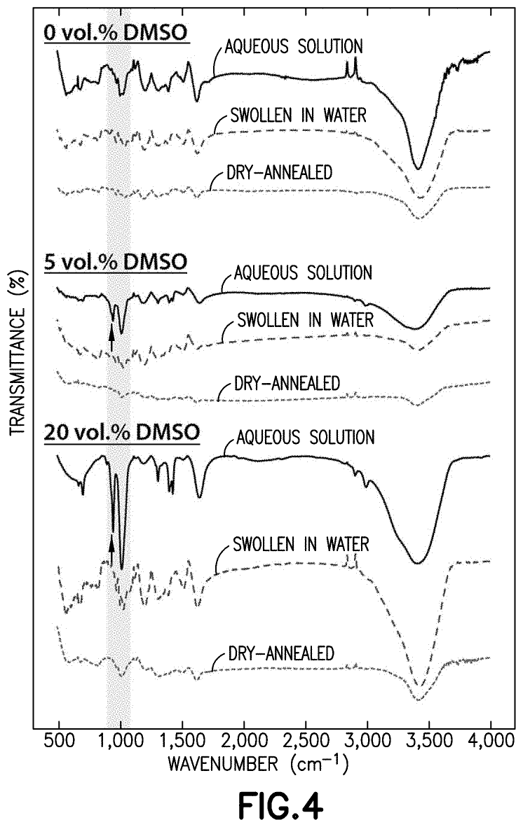

As shown in FIGS. 3A-B, adding 5 vol. % DMSO (it is noted that the amount of DMSO does not affect the tunable swelling behavior and 5 vol % is merely used as an example) into a pure PEDOT:PSS aqueous solution and subsequently dry-annealing the mixture under suitable conditions (e.g., about 12 to 48 h at 50° C. to 90° C. drying followed by 1 to 10 cycles of 30 min annealing at 100° C. to 200° C.) to thoroughly remove both water and DMSO, pure PEDOT:PSS microballs (via isotropic dry-annealing) and films (via anisotropic dry-annealing) can be formed (FIGS. 3A-B). The thorough removal of both water and DMSO in accordance with the present methods is demonstrated by the characteristic FT-IR spectral absorption peaks for DMSO (e.g., 1,024 cm⁻¹ for stretching vibration of sulfoxyl group; 950 cm⁻¹ for bending and 3,000 and 2,910 cm⁻¹ for stretching vibration of methyl group) clearly present in DMSO-containing aqueous PEDOT:PSS solutions while such absorption peaks completely disappear in the FT-IR spectra of the dry-annealed PEDOT:PSS (FIG. 4). This indicates that the added DMSO is fully removed during the present invention dry-annealing process, yielding pure PEDOT:PSS. The use of other polar organic solvents (other than DMSO), particularly volatile polar organic solvents, such as, for example, ethylene glycol (EG), xylene, methanol, dimethylformamide (DMF), and tetrahydrofuran (THF) will also demonstrate these results.

The resulting the dry-annealed conductive polymer, also referred to herein as the hydrogel precursor (e.g., pure PEDOT:PSS hydrogel precursor) can be converted into stable pure conducting polymer hydrogels by rehydrating/swelling in a suitable rehydrating material (e.g., water, PBS, bodily fluids, etc.). The swelling behavior of the pure conducting polymer hydrogels is strongly affected by the dry-annealing conditions (e.g. see FIG. 1C). As shown, isotropic dry-annealing of a mechanically unconstrained PEDOT:PSS droplet leads to isotropic swelling behavior (FIG. 3C, E, G, I), while the anisotropic drying of a mechanically constrained PEDOT:PSS solution (i.e., drying on a substrate to form a film) provides anisotropic swelling behavior over the thickness direction of the film (FIG. 3D, F, H. J). The swelling ratio of pure conducting polymer hydrogels in a wet environment is also affected by the concentration of polar organic solvent (e.g. DMSO) in the pure conducting polymer aqueous solution. As depicted in FIG. 6, the swelling ratio of pure PEDOT:PSS hydrogels increases with the DMSO concentration up to 20 vol. %, and then the swelling ratio decreases with increasing DMSO concentration beyond 20 vol %, both in PBS and in deionized water. In is noted that, as depicted in FIG. 6, the pure PEDOT:PSS hydrogels fabricated with the same DMSO concentration exhibit lower swelling ratio in PBS than in deionized water. Without being bound by theory, it is believed that this is potentially due to the ionic strength and subsequent change of equilibrium swelling in PBS. This similar swelling behavior would be present in pure conducting polymer materials in addition to PEDOT:PSS, whether formed using DMSO or other polar organic solvents.

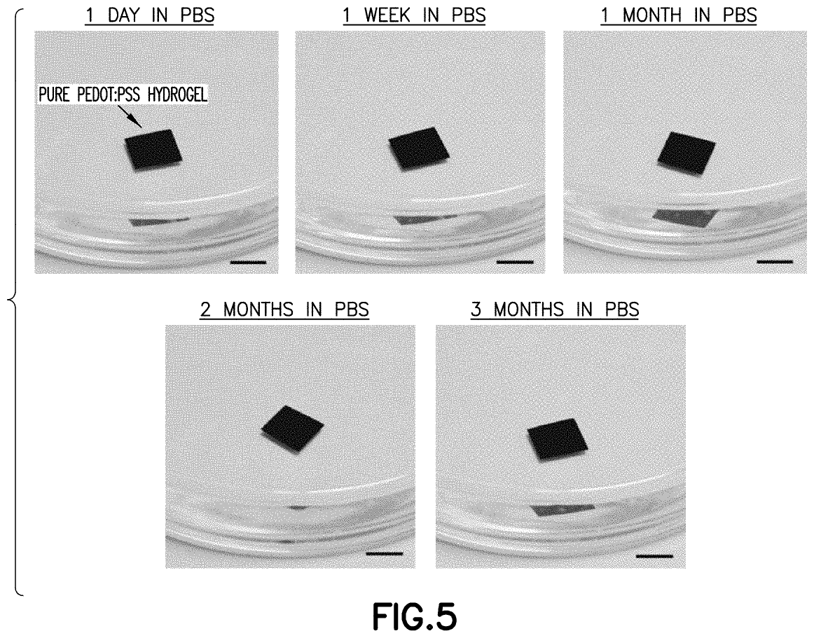

The pure conducting polymer hydrogels in accordance with the present invention demonstrate high water contents of at least about 50 wt. %, more preferably at least about 55 wt. %, more preferably at least about 60 wt. %, more preferably at least about 65 wt. %, more preferably at least about 70 wt. %, more preferably at least about 75 wt. %, more preferably at least about 80 wt. % water (in some preferred embodiments, the pure conducting polymer hydrogels contain about 80-87 wt. % water) and substantially enhanced long-term stability in wet physiological environments (e.g., no observable damage after at least about 1 month, more preferably at least about 2 months, more preferably at least 3 months in PBS) as demonstrated of the pure PEDOT:PSS hydrogel in FIG. 5.

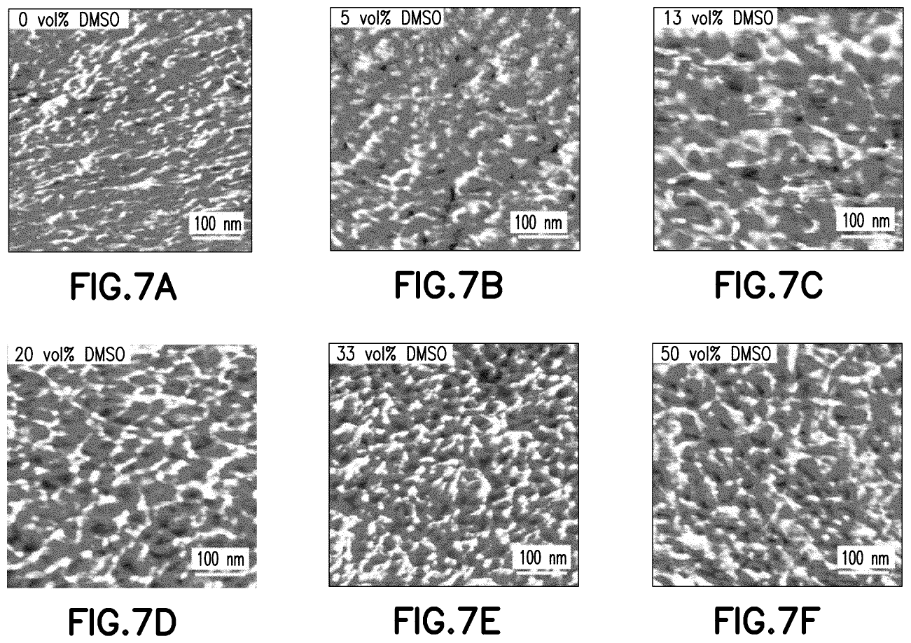

As noted, by varying the concentration of the polar organic solvent in the pure conducting polymer solution, the morphologies of the resulting dry-annealed pure conducting polymer (also referred to as the pure conducting polymer hydrogel precursor) likewise change. For example, as depicted in the AFM phase images of dry-annealed pure PEDOT:PSS (hydrogel precursor) in FIG. 7, in comparison with the pristine PEDOT:PSS film without adding DMSO (in accordance with conventional techniques, and as depicted in FIG. 7A), the introduction of DMSO (5˜50 vol. %) results in the increased phase separation between PEDOT-rich domains (light/white color) and PSS-rich domains (dark/grey-black color), which originates from the enhanced crystallinity of π stacking of PEDOT chains during the dry-annealing process. Notably, higher DMSO concentration further facilitates the growth and interconnection of PEDOT-rich domains, and a well-percolated ordered nanofibrillar network of PEDOT-rich domains start to appear at DMSO concentration over 13 vol. % (FIG. 7D-F). Such interconnected nanofibrillar morphology can potentially provide improved electrical conductivity and mechanical properties by forming more effective pathways for both electron transfer and sustaining mechanical forces. However, too high DMSO concentration (over 50 vol. %) begins to lead to the aggregation of the fibrous networks of PEDOT-rich domains (FIG. 7F), similar to the instant aggregation or gelation phenomena previously reported in the addition of sulfuric acid and ionic liquids.

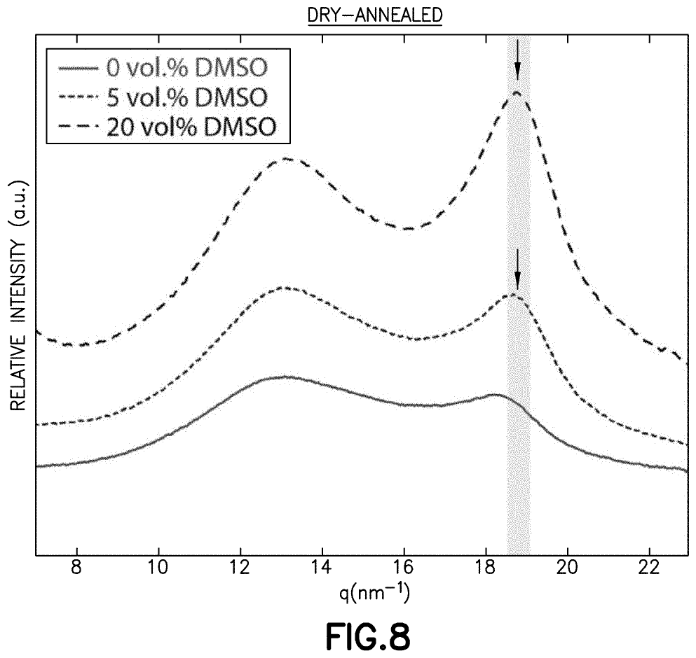

Wide angle X-ray scattering (WAXS) tests were also performed in order to further study the effect of varying DMSO concentrations on the morphologies of the resultant dry-annealed pure PEDOT:PSS (hydrogel precursors). The WAXS profiles of the dry-annealed pure PEDOT:PSS films based on varying concentrations of DMSO exhibit the increasing intensity of the scattering vector (q) peak at ˜19 nm⁻¹ (characteristic peak for PEDOT crystalline domain) (FIG. 8). As the higher amplitude of intensity in WAXS profile at the characteristic peak for PEDOT crystalline domain (19 nm⁻¹) indicates the higher degree of the crystallization of PEDOT domains, the WAXS characterization of the pure PEDOT:PSS prepared with different DMSO concentrations shows the effective enhancement in the crystallization of PEDOT by the proposed method.

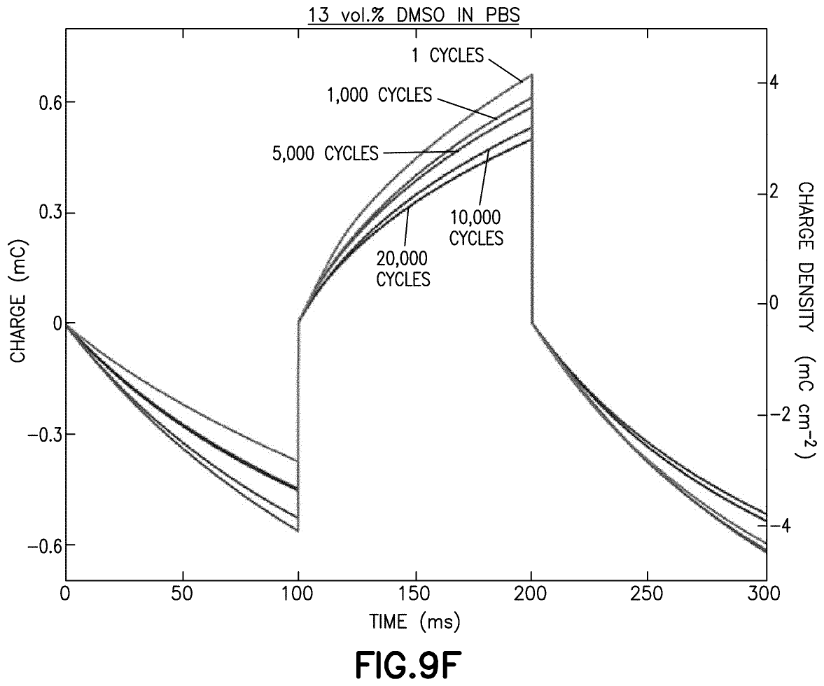

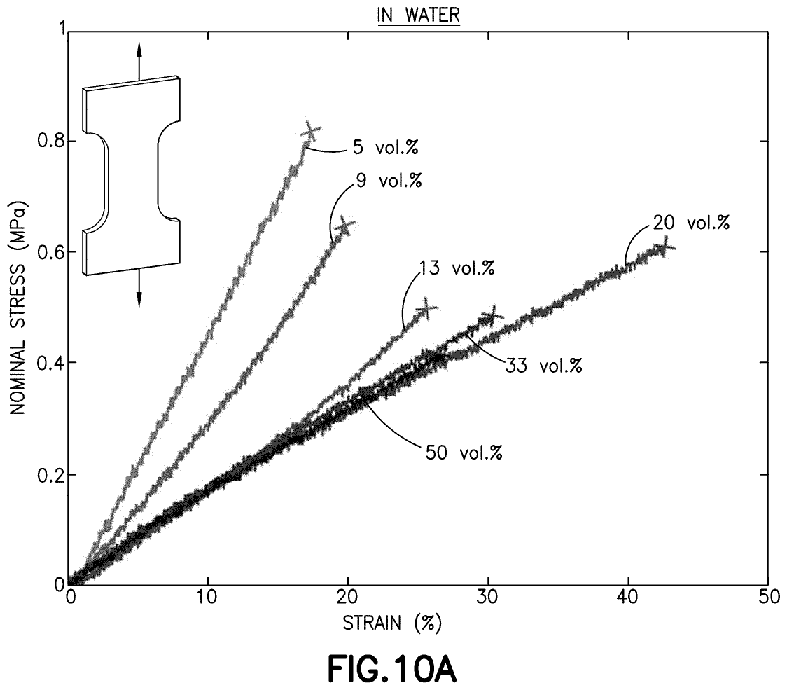

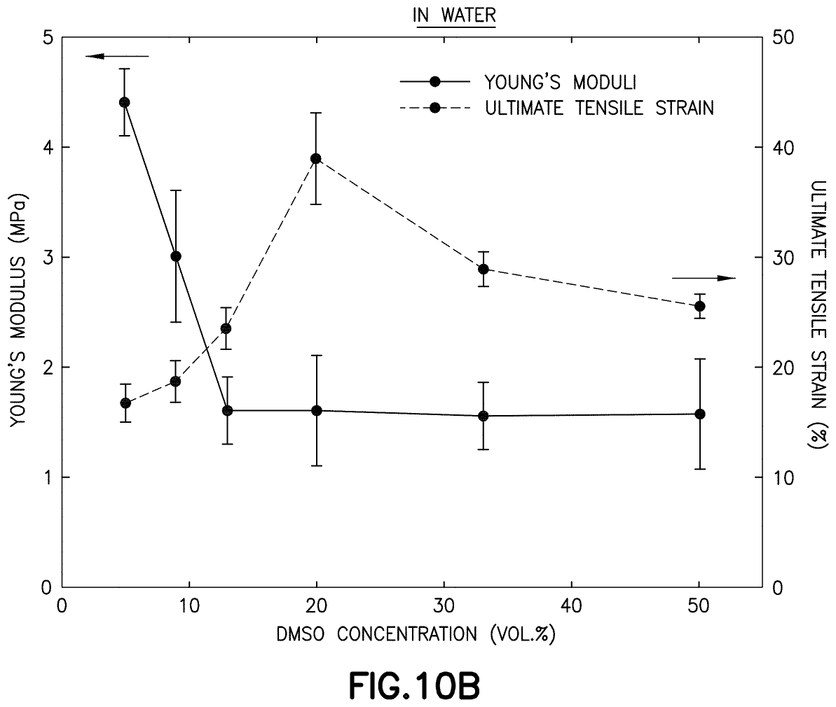

In view of the superior stability and free-standing nature of the present invention pure conducting polymer hydrogels in wet physiological environments, the mechanical and electrical properties of free-standing pure conducting polymer hydrogel films where systematically characterized both in PBS and in deionized water. Nominal strain vs. stress curves in tensile tests demonstrate that the Young's moduli of pure PEDOT:PSS hydrogels in PBS are in the range of 2˜10 MPa (FIG. 9A-B), which are comparable to that of soft elastomers such as polydimethylsiloxane (PDMS) (e.g., Young's moduli in the range of 1˜10 MPa) and several orders of magnitude lower than conventional rigid materials in bioelectronic devices. The mechanical compliance of pure conducting polymer hydrogels according to the present invention can thus offer improved long-term biomechanical interactions with biological tissues as demonstrated by PDMS-based bioelectronic implants. Notably, the pure PEDOT:PSS hydrogels of the present invention exhibited smaller Young's moduli in deionized water (e.g., in the range of 1˜5 MPa) than in PBS (FIG. 10). Without being bound by theory, it is believe that this potentially stems from higher swelling ratio and consequent higher equilibrium water contents of pure PEDOT:PSS hydrogels in deionized water than in PBS (˜87 wt. % in deionized water vs. ˜80 wt. % in PBS) (FIG. 6).

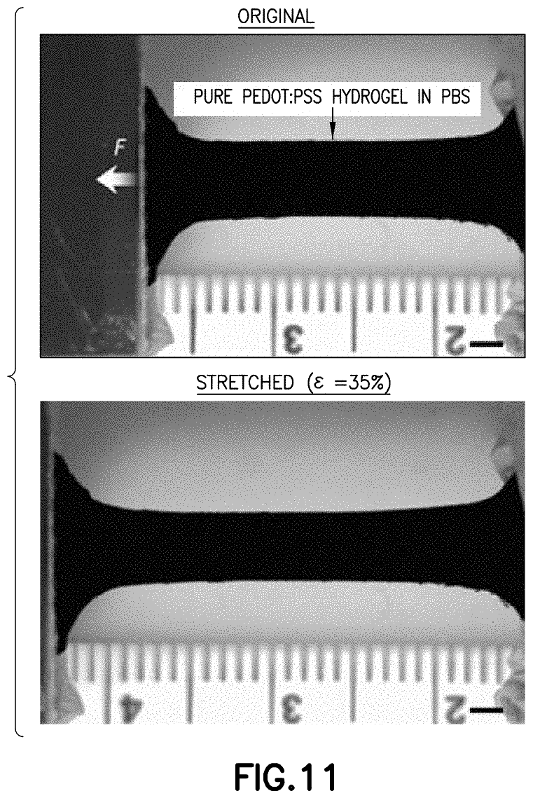

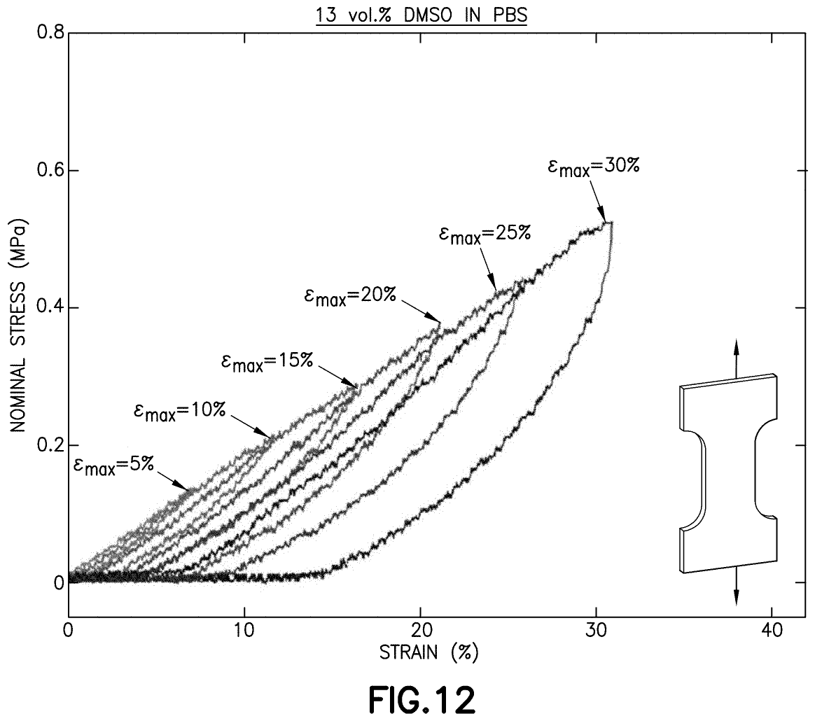

As demonstrated in FIGS. 9B and 10, the pure PEDOT:PSS hydrogels show a gradual reduction in Young's moduli with the increase of DMSO concentration up to 13 vol. % and then keep nearly constant for higher DMSO concentrations, both in PBS and in deionized water. As further demonstrated, the stretchability of the pure PEDOT:PSS hydrogels increases with DMSO concentration up to 20 vol. % and then decreases for higher DMSO concentrations. As demonstrated in FIGS. 11 and 12, the ultimate tensile strain of the pure PEDOT:PSS hydrogels according to embodiments of the invention (20 vol. % DMSO) reached over 35% in PBS and over 40% in deionized water, which are significantly higher than the dry-annealed pure PEDOT:PSS film (hydrogel precursor) before swelling (<10% strain) and closely match the stretchability of biological tissues such as neural tissues (˜20% strain) and skin (˜50% strain). This enhanced stretchability of the pure PEDOT:PSS hydrogels of the present invention can be attributed to the phase separation of PEDOT and PSS during the dry-annealing process and the resultant interconnected network of PEDOT-rich domains and PSS-rich regions in hydrogel, which is in good agreement with the morphological evolution observed in the AFM phase images (FIG. 7). Similar enhanced stretchability is also observed for all of the present invention conducting polymer materials fabricated using DMSO or alternate polar organic solvent materials.

In order to test the electrical conductivity of pure conductive polymer hydrogels according to the present invention, the concentration of polar organic solvent, in this case DMSO, was varied while maintaining constant dry-annealing conditions. In particular, the DMSO concentration in PEDOT:PSS aqueous solution was varied within the range of 5˜50 vol % while maintaining dry-annealing conditions of 24 h at 60° C. drying followed by 3 cycles of 30 min annealing at 130° C. to produce a batch of pure PEDOT:PSS hydrogels. During rehydration, the dry-annealed pure PEDOT:PSS absorbs water and ions, significantly decreasing its electrical conductivity from ˜500 S cm⁻¹ in the dry state to less than 50 S cm⁻¹ in the rehydrated/swollen state (both in PBS and in deionized water) (see FIG. 9C).

As demonstrated, the concentration of DMSO plays an important role in the electrical conductivity of the pure conductive polymer hydrogels. In particular, the electrical conductivity and DMSO concentration display a non-monotonic relationship with the highest conductivity of 20 S cm⁻¹ in PBS and ˜40 S cm⁻¹ in deionized water achieved at about 13 vol. % DMSO concentration at the above-noted dry-annealing conditions (FIG. 9C). The addition of this optimized amount of DMSO (i.e., 13 vol. %) in the PEDOT:PSS solution allowed a more preferred formation of a well-interconnected network of hydrophobic semi-crystalline PEDOT-rich domains, which can offer enhanced conducting pathways against the fast swelling of hydrophilic PSS-rich regions (as depicted in FIG. 7C). As depicted in FIG. 9C, the electrical conductivity decreased with increasing DMSO concentration over 13 vol. %, which might be attributed to an unfavorable aggregation of the nanofibrillar PEDOT-rich network by the presence of an excess of DMSO.

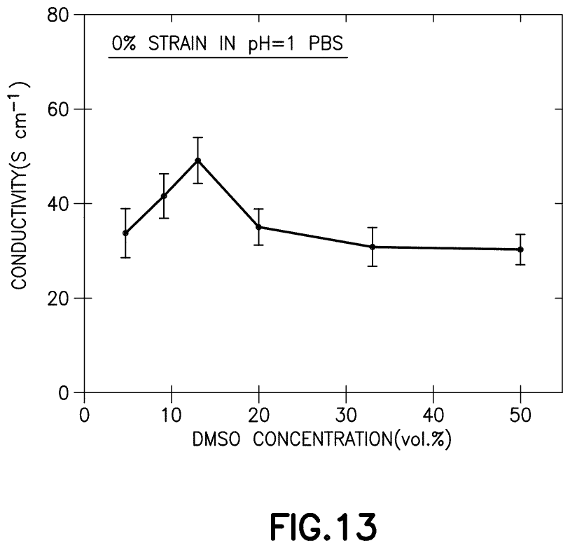

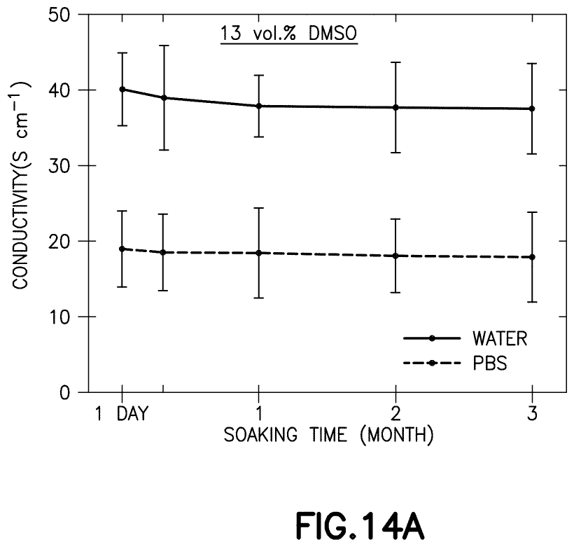

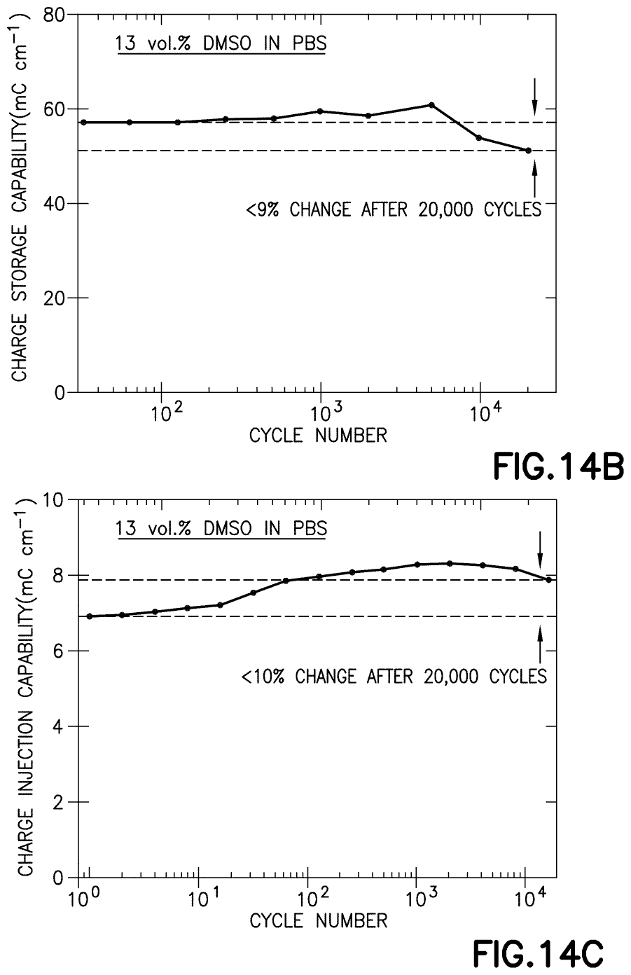

As shown in FIG. 9C, this same pure PEDOT:PSS hydrogel exhibits a reduced electrical conductivity in physiological condition (i.e., in PBS) as compared to deionized water. Typical PEDOT:PSS aqueous solutions and pure PEDOT:PSS hydrogels in deionized water are acidic (pH 1˜2) due to the presence of PSS. A physiologically-relevant environment such as PBS can neutralize pure PEDOT:PSS hydrogels and such neuralization of acidic PEDOT:PSS has been reported to substantially decrease electrical conductivity by the disruption of the π-π stacking of PEDOT crystalline domain and the consequent reduction in bipolaron concentration (i.e., charge carrier density). It was determined that the electrical conductivity of pure PEDOT:PSS hydrogels in PBS adjusted to pH 1 recovers high electrical conductivity measured in deionized water (˜40 S cm₋₁) (see FIG. 13). It should be noted that, despite the reduced electrical conductivity in PBS, the optimized electrical conductivity of ˜20 S cm⁻¹ in PBS (˜40 S cm⁻¹ in deionized water) for the pure PEDOT:PSS hydrogels is the highest among all pure conducting polymer hydrogels previously reported. Furthermore, the electrical conductivity of pure PEDOT:PSS hydrogels exhibit superior stability in wet environments with negligible decrease in stability for over 3 months both in PBS and in deionized water (see FIG. 14A). Such high and stable electrical conductivity in wet physiological environments ensures more efficient and reliable bioelectronic stimulation and recoding, and therefore, is highly advantageous for use in many applications including bioelectronic devices and applications.

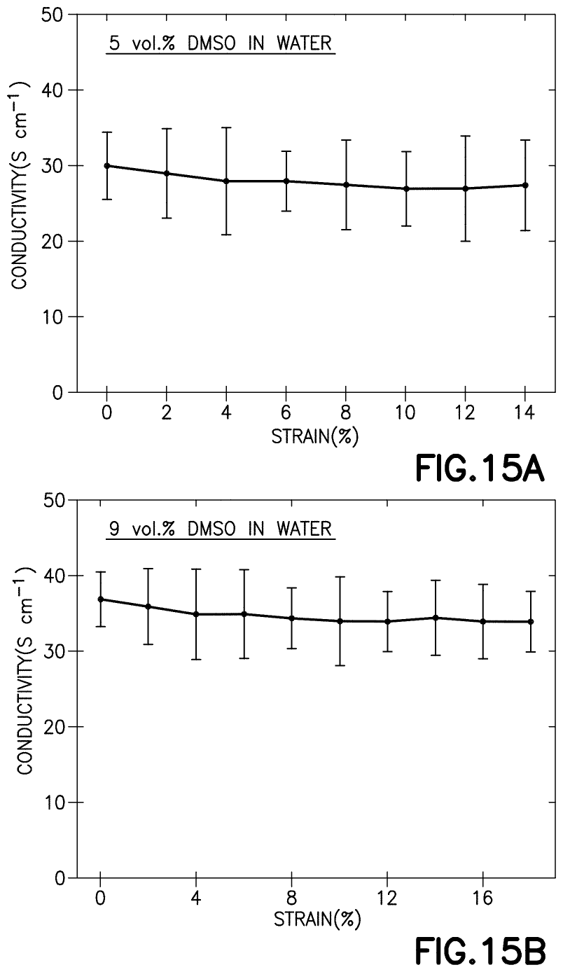

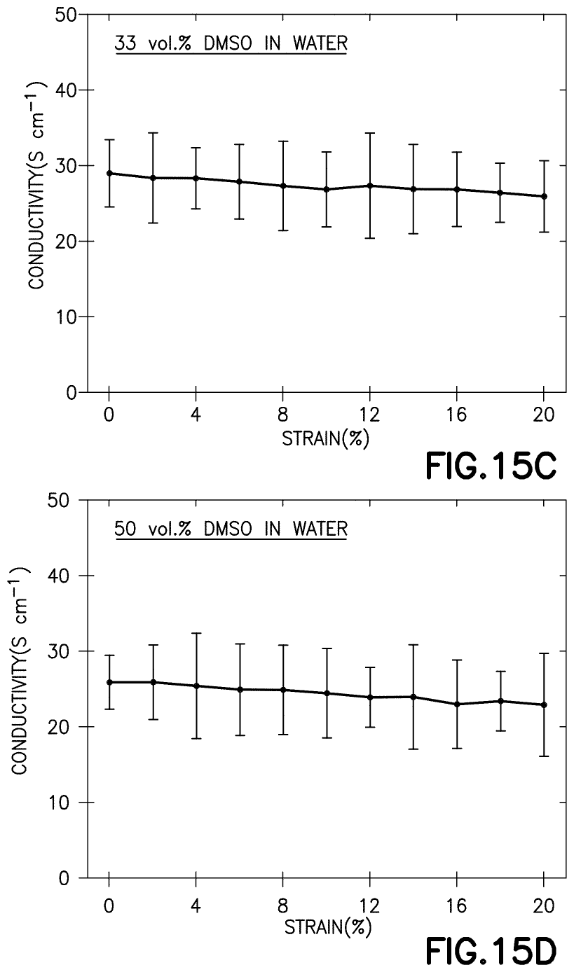

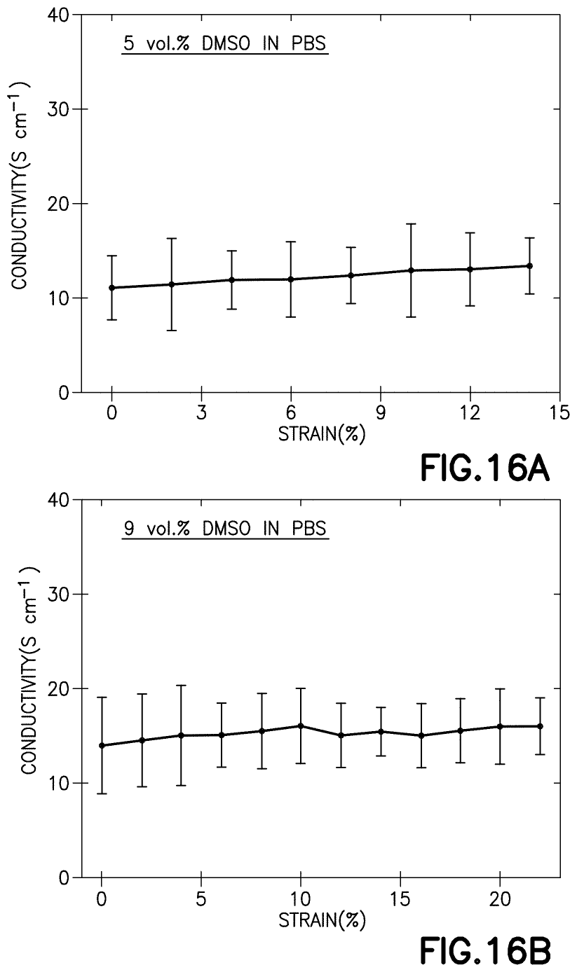

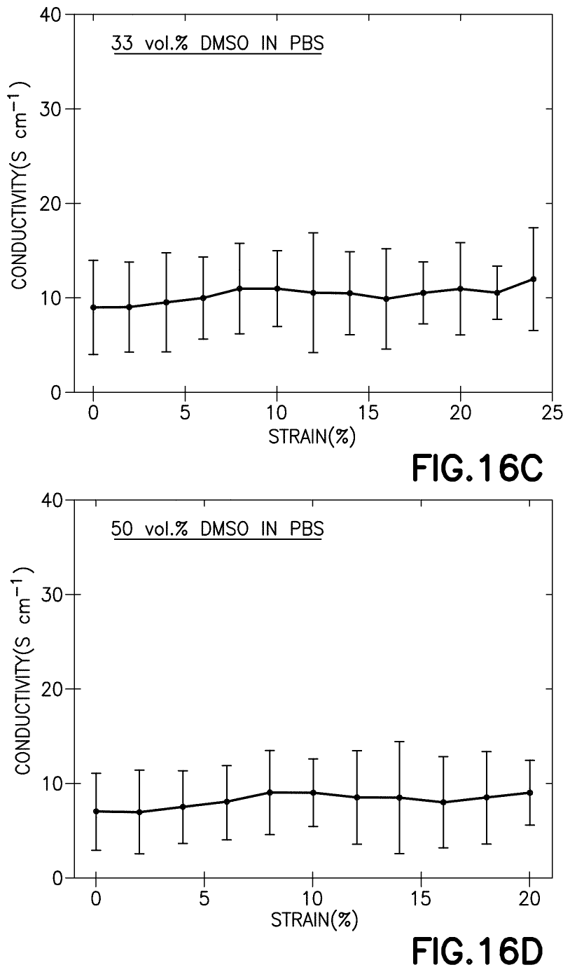

As depicted in FIGS. 9D and 15, upon tensile deformation, the present invention pure PEDOT:PSS hydrogels in deionized water display a slight reduction in conductivity similar to conventional stretchable PEDOT:PSS films. Interestingly, as depicted in FIG. 16, the tensile deformation of the present invention pure PEDOT:PSS hydrogels in PBS appears to slightly increase the electrical conductivity.

Further electrical properties, including charge storage capability (CSC) and charge injection capacity (CIC) of the present invention pure conducting polymer hydrogels were studied in order to evaluate performance capabilities in applications such as bioelectronics. In particular, cyclic voltammetry (CV) of the pure PEDOT:PSS hydrogels measured on Pt electrode demonstrated that pure PEDOT:PSS hydrogels in accordance with the present invention (using 13 vol. % DMSO concentration) possess a high CSC value of 60 mC cm⁻² and superior electrochemical stability against charging and discharging cycles in a wet physiological environment (in this case, PBS) with less than a 9% reduction in CSC after 20,000 CV cycles (see FIGS. 9E and 14B). The pure PEDOT:PSS hydrogels (using 13 vol. % DMSO concentration) also exhibited a high CIC value of 8.3 mC cm⁻² and stability (less than 10% change after 20,000 cycles) in PBS (see FIGS. 9F and 14C). These high CSC and CIC values of pure PEDOT:PSS hydrogels together with their soft and wet properties are particularly desirable for bioelectronic stimulation applications, potentially in combination with other highly conductive electrodes such as metal nanocomposites to minimize power consumption, etc.

According to embodiments of the present invention, the hydrogels can be patterned into complex geometries. In particular, patterning of electrodes into complex geometries is a crucial step for fabricating bioelectronic devices. Complicated preparation steps and/or poor stability in aqueous conditions have significantly limited the realization of facile patterning of conductive hydrogels with complex designs using conventional materials and methods. The present invention provides materials and methods that allow for the use of advanced manufacturing techniques such as 3D printing in order to fabricate highly conductive, stable and stretchable hydrogel patterns. Moreover, the present invention provides tunable swelling behaviors (e.g., anisotropic or isotropic) of the pure conductive polymer hydrogels, which further provides superior compatibility with various fabrication processes by minimizing the geometric distortion and interfacial delamination from the substrate in wet environments.

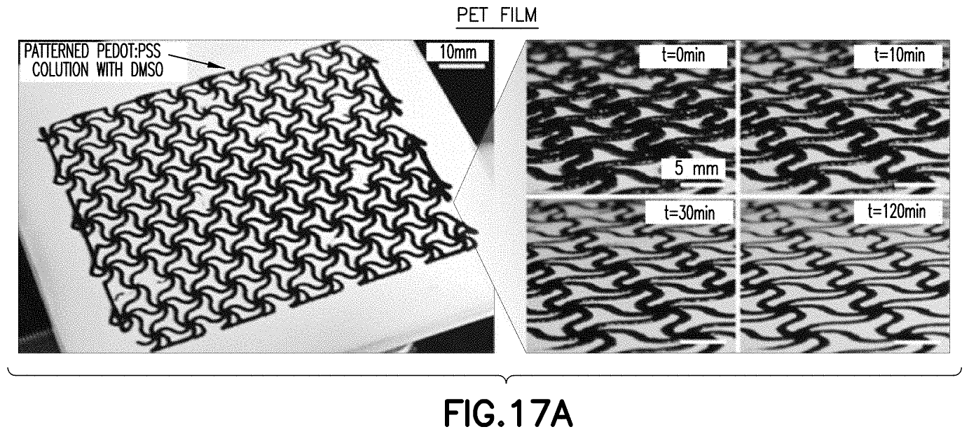

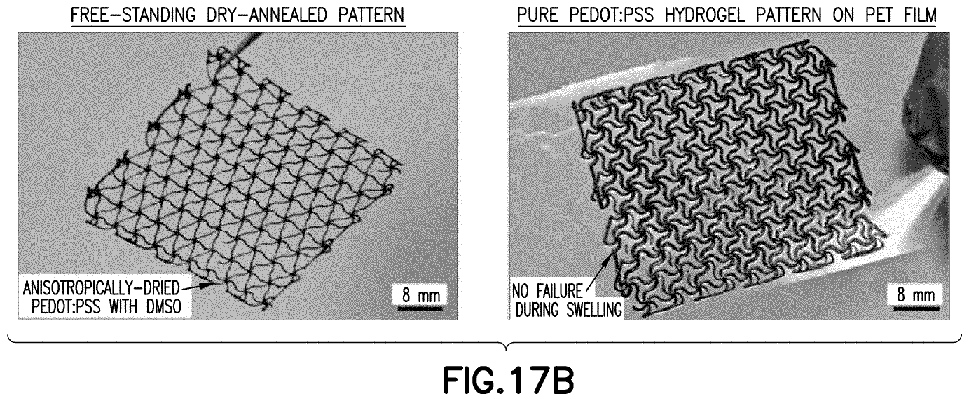

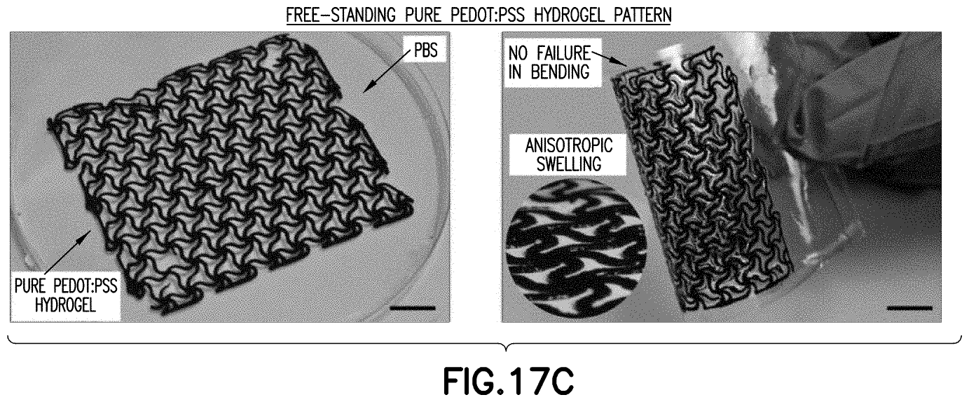

According to an embodiment of the present invention, a wavy mesh was fabricated by direct-ink writing of a PEDOT:PSS aqueous solution onto a substrate to form a pattern complex geometry depicted in FIG. 17A. The printed patterns were dry-annealed anisotropically under the mechanical constraint of the substrate. The dry-annealed patterns in a free-standing form and patterned on a PET film were readily converted into pure PEDOT:PSS hydrogels by swelling in a wet environment. For example, the pure PEDOT:PSS hydrogel patterns can be prepared either into free-standing structures by peeling off of a low-adhesion substrate (e.g., polypropylene and polydimethylsiloxane) (FIG. 17B) or forming into robust laminates by patterning on high-adhesion substrates (e.g., polyethylene terephthalate) (FIG. 17C). The anisotropic swelling of the hydrogel (which resulted from a mechanically constrained dry-annealing process) greatly benefits the fabrication of conductive hydrogel patterns by preventing undesirable dimensional changes in the free-standing structures (as shown in FIG. 17B) and by preventing interfacial failures in laminates (as shown in FIG. 17C), which can be advantageous for other fabrication techniques such as ink-jet printing and spin-coating.

It is noted that most devices in applications (e.g., bioelectronic applications) require multiple layers for insulation, encapsulation, electrodes, etc. Therefore, it is important to form robust and stable laminates to ensure reliable functions in use. Conventional conducting polymer hydrogels swell in all direction (isotropic swelling) when placed in contact with liquid or wet environments, which risks interfacial failure due to geometric distortion of the swollen polymer laminated on the substrate. The present invention overcomes this limitation by providing a method in which it is possible to control isotropy of the pure conducting polymer hydrogel swelling process. Using the present method, the dry-annealing process can be carried out so as to pre-determine the consequent swelling behavior (isotropic dry-annealing gives isotropic swelling; anisotropic dry-annealing gives anisotropic swelling). Anisotropic swelling provides great benefits for laminate structures of pure conducting polymer hydrogels in by avoiding the geometric distortion in the planar direction by controlling the swelling into the out-of-plane direction (thickness direction).

The present invention provides a simple yet highly effective strategy to fabricate pure conducting polymer hydrogels that possess high electrical conductivity (e.g., as high as ˜20 S cm⁻¹ in PBS and ˜40 S cm⁻¹ in deionized water), high stretchability (>35% strain) with low Young's modulus (˜2 MPa), and superior mechanical, electrical and electrochemical stability in wet physiological environments. The swelling behavior of the pure PEDOT:PSS hydrogels can be tuned by mechanical constraints in the dry-annealing process, providing additional flexibility in the processing and bioelectronic device fabrication. The present materials and methods allow for the patterning of stable pure conductive hydrogels into complex geometries and various form factors by, for example, direct-ink writing techniques. The present materials and methods, thus, provide novel pure conductive hydrogels that synergistically combine outstanding electrical and mechanical properties, which will find great use in various applications including next-generation hydrogel bioelectronic devices and applications.

### Materials and Methods for Experimental Data

### Material Preparation

PEDOT:PSS aqueous solution (1.1˜1.3% solid content, Clevio™ PH1000, Haraeus Electronic Materials) was stirred vigorously for 6 h, and then dimethyl sulfoxide (DMSO, Sigma-Aldrich) was added in the range of 0˜50 vol. % of the final solution. Upon further stirring for 24 h at room temperature, the mixed solution was drop-casted directly onto polypropylene (PP) or polyethylene terephthalate (PET) substrate and dried at 60° C. for 24 h followed by multiple cycles of annealing at 130° C. (3 cycles with 30 min per each cycle) to yield pure PEDOT:PSS films. Free-standing pure PEDOT:PSS films were obtained by peeling off the dry-annealed samples from PP substrate. To prepare pure PEDOT:PSS microballs, a droplet of the mixed solution was suspended at the tip of a micropipette, and dry-annealed similar to the film samples. To investigate the swelling behavior, dry-annealed pure PEDOT:PSS free-standing films or microballs were immersed into deionized water or PBS (Sigma-Aldrich).

### FT-IR Characterization

Free-standing dry-annealed and swollen pure PEDOT:PSS hydrogel films were prepared and used to characterize the infrared spectra by a Fourier-transform infrared (FT-IR) spectrometer (Vertex 70, Bruker). For PEDOT:PSS aqueous solutions, a KBr pellet was employed as a substrate.

### AFM Phase Imaging

AFM phase images and surface roughness data were acquired by atomic force microscope (MFP-3D, Asylum Research). Dry-annealed free-standing PEDOT:PSS films were directly attached onto sample stage by double-sided carbon tape.

### Wide-Angle X-ray Scattering (WAXS) Characterization

Transmission WAXS measurements were carried out by using a SAXSLAB instrument at the MIT Center for Materials Science and Engineering (CMSE).

### Electrical Conductivity Measurement

Electrical conductivity for all the samples was measured by using a standard four-point probe (Keithley 2700 digital multimeter, Keithley). Dry-annealed pure PEDOT:PSS films (i.e., hydrogel precursors) and hydrogels were cut into rectangular shapes (30 mm in length and 5 mm in width). Copper wire electrodes (diameter, 0.5 mm) were attached onto the surface of dry-annealed films by applying silver paste, while platinum wire electrodes (diameter, 0.5 mm) were employed for hydrogels to avoid the corrosion in wet environments. For pure PEDOT:PSS hydrogels, a humidifier was used to keep the samples hydrated throughout all experiments. For the conductivity stability tests, the pure PEDOT:PSS hydrogels were immersed in deionized water or in PBS and tested at different time points (one day, one week, one month, two months, and three months).

### Mechanical Characterization

All samples for mechanical characterizations were performed by using fully swollen pure PEDOT:PSS free-standing films with a dog-bone shape either in deionized water or in PBS. Tensile property of the samples was measured by a mechanical testing machine (U-Stretch with 4.4 N load cell, CellScale). All mechanical characterizations were performed within the submersion stage filled with either deionized water or PBS to avoid dehydration of the hydrogels.

### Cyclic voltammetry

Cyclic voltammetry of pure PEDOT:PSS hydrogels was performed by using a potentiostat/galvanostat (VersaSTAT 3, Princeton Applied Research). Pt wires (diameter, 1 mm) were employed as both working and counter electrodes, and Ag/AgCl electrode was used as the reference electrode. Prior to all measurements, the electrodes were cleaned successively with abrasive paper, deionized water, and ethyl alcohol. PBS was used as the supporting electrolyte. CSC was calculated from the measured CV curves as:

$$CSC = {\int }_{{E}_{2}}^{{E}_{1}} \frac{i ( E )}{2 vA} \qquad ( 1 )$$

where v is the scan rate, E₂−E₁ is the potential window, i is the current at each potential, and A is the area of the pure PEDOT:PSS hydrogel film.

In order to characterize charge injection performance of pure PEDOT:PSS hydrogels, electrochemical current pulse injection (in recurrent potential pulses mode) tests were performed in PBS by using an electrochemical workstation (VersaSTAT 3, Ametek Scientific Instruments). Ag/AgCl electrode was employed as a reference electrode, platinum wires (diameter, 1 mm) as counter and working electrodes. CIC was calculated from the measured charge injection curves as:

$$CIC = \frac{{Q}_{inj ( c )} + {Q}_{inj ( a )}}{A} \qquad ( 2 )$$

where CIC represents the charge density of pure PEDOT:PSS hydrogel between the reduction potential (cathodal limit) and the oxidation potential (anodal limit), Q_{inj(c)} is the total delivered (or injected) charge in cathodal phase, Qᵢₙⱼ₍ₐ₎ is the total delivered (or injected) charge in anodal phase, and A is the area of the pure PEDOT:PSS hydrogel, respectively.

### Patterning

Patterning of pure PEDOT:PSS hydrogels was performed by using a custom direct ink writing (DIW) printer. Print paths were generated via production of G-code that controls the XYZ motion of the 3D robotic gantry (Aerotech). Pressure based microdispenser (Ultimus V, Nordson EFD) was used to print inks with a 400 μm diameter nozzle (Smoothflow tapered tip, Nordson EFD) on PP or PET substrates via the custom LabVIEW interface (National Instruments). The ink was prepared by evaporating water from the PEDOT:PSS aqueous solution with 13 vol. % DMSO at room temperature with vigorous stirring until the water contents of the solution was reduced to around 30% of the original solution.

What is claimed is:

1. A pure conducting polymer hydrogel comprising:
at least about 50 wt % water, based on total weight of the pure conducting polymer hydrogel; and
up to about 50 wt % of a conducting polymer component, the conducting polymer component comprising at least about 99% of one or more conducting polymers and less than about 1% of additives, crosslinkers and materials other than the one or more conducting polymers,
wherein the pure conducting polymer hydrogel has an electrical conductivity of at least about 1 S cm⁻¹ in PBS and at least about 1 S cm⁻¹ in deionized water, a stretchability of at least about 10% strain, and a Young's modulus of no greater than about 20 MPa.

2. The hydrogel of claim 1, wherein the one or more conducting polymers are selected from one or more polythiophenes.

3. The hydrogel of claim 2, wherein the one or more conducting polymers are selected from poly(3,4-ethylenedioxythiophene):poly(styrene sulfonate) (PEDOT:PSS), poly(3,4-ethylenedioxyselenophene) (PEDOS), poly(3,4-ethylenedithiathiophene) (PEDTT), poly(thieno[3,4-b]-1,4-oxathiane) (PEOTT), poly(N-methyl-3,4-dihydrothieno[3,4-b][1,4]oxazine) (PMDTO), poly(hydroxymethylated-3,4-ethylenedioxylthiophene) (PEDOT-MeOH), and combinations thereof.

4. The hydrogel of claim 2, wherein the one or more conducting polymers is poly(3,4-ethylenedioxythiophene):poly(styrene sulfonate) (PEDOT:PSS).

5. The hydrogel of claim 1, having an electrical conductivity of at least about 10 S cm⁻¹ in PBS and at least about 20 S cm⁻¹ in deionized water.

6. The hydrogel of claim 5, having an electrical conductivity of at least about 20 S cm⁻¹ in PBS and at least about 40 S cm⁻¹ in deionized water.

7. The hydrogel of claim 1, having a stretchability of at least about 20% strain.

8. The hydrogel of claim 1, having a stretchability of at least about 35% strain.

9. The hydrogel of claim 1, having a Young's modulus of no greater than about 10 MPa.

10. The hydrogel of claim 1, having a Young's modulus of no greater than about 2 MPa

11. The hydrogel of claim 1, comprising at least about 80 wt % water, based on total weight of the pure conducting polymer hydrogel, and up to about 20 wt % of the conducting polymer component.

12. A pure conducting polymer hydrogel precursor comprising:
at least about 99% of one or more conducting polymers; and
less than about 1% of additives, crosslinkers and materials other than the one or more conducting polymers;
wherein placing the hydrogel precursor in a wet environment hydrates and swells the hydrogel precursor to form a hydrogel, the hydrogel having an electrical conductivity of at least about 1 S cm⁻¹ in PBS and at least about 1 S cm⁻¹ in deionized water, a stretchability of at least about 10% strain, and a Young's modulus of no greater than about 20 MPa.

13. The hydrogel precursor of claim 12, having one or more predetermined swelling properties.

14. The hydrogel precursor of claim 13, wherein the predetermined swelling property is anisotropic swelling.

15. The hydrogel precursor of claim 14, wherein the hydrogel precursor is in the form of a film that swells in a thickness direction.

16. The hydrogel precursor of claim 13, wherein the predetermined swelling property is isotropic swelling.

17. The hydrogel precursor of claim 12, wherein the one or more conducting polymers are selected from one or more polythiophenes.

18. The hydrogel of claim 17, wherein the one or more conducting polymers are selected from poly(3,4-ethylenedioxythiophene):poly(styrene sulfonate) (PEDOT:PSS), poly(3,4-ethylenedioxyselenophene) (PEDOS), poly(3,4-ethylenedithiathiophene) (PEDTT), poly(thieno[3,4-b]-1,4-oxathiane) (PEOTT), poly(N-methyl-3,4-dihydrothieno[3,4-b][1,4]oxazine) (PMDTO), poly(hydroxymethylated-3,4-ethylenedioxylthiophene) (PEDOT-MeOH), and combinations thereof.

19. The hydrogel of claim 17, wherein the one or more conducting polymers is poly(3,4-ethylenedioxythiophene):poly(styrene sulfonate) (PEDOT:PSS).

20. A method of fabricating a pure conducting polymer hydrogel precursor comprising:
mixing one or more conducting polymers with a first solvent to form an aqueous solution;
adding one or more polar organic solvent to the aqueous solution; and
performing dry-annealing to form the hydrogel precursor, the pure conducting polymer hydrogel precursor comprising at least about 99% of one or more conducting polymers and less than about 1% of additives, crosslinkers and materials other than the one or more conducting polymers.

21. The method of claim 20, wherein the one or more conducting polymers are selected from one or more polythiophenes.

22. The method of claim 21, wherein the one or more conducting polymers are selected from poly(3,4-ethylenedioxythiophene):poly(styrene sulfonate) (PEDOT:PSS), poly(3,4-ethylenedioxyselenophene) (PEDOS), poly(3,4-ethylenedithiathiophene) (PEDTT), poly(thieno[3,4-b]-1,4-oxathiane) (PEOTT), poly(N-methyl-3,4-dihydrothieno[3,4-b][1,4]oxazine) (PMDTO), poly(hydroxymethylated-3,4-ethylenedioxylthiophene) (PEDOT-MeOH), and combinations thereof.

23. The method of claim 21, wherein the one or more conducting polymers is poly(3,4-ethylenedioxythiophene):poly(styrene sulfonate) (PEDOT:PSS).

24. The method of claim 20, wherein the one or more polar organic solvent is selected from dimethyl sulfoxide (DMSO), ethylene glycol (EG), xylene, methanol, dimethylformamide (DMF), tetrahydrofuran (THF), and combinations thereof.

25. The method of claim 20, wherein dry-annealing is performed to provide one or more tunable swelling properties of the hydrogel precursor in wet physiological environments.

26. The method of claim 25, wherein the dry-annealing is performed under mechanically constrained conditions to form a hydrogel precursor, wherein the hydrogel precursor isotropically swells to form a hydrogel in a wet environment.

27. The method of claim 25, wherein the dry-annealing is performed under mechanically unconstrained conditions to form a hydrogel precursor, wherein the hydrogel precursor anisotropically swells to form a hydrogel in a wet environment.

28. A method of fabricating a pure conducting polymer hydrogel comprising:
mixing one or more conducting polymers with a first solvent to form an aqueous solution;
adding one or more polar organic solvent to the aqueous solution; and
performing dry-annealing to form a hydrogel precursor, the hydrogel precursor comprising at least about 99% of one or more conducting polymers and less than about 1% of additives, crosslinkers and materials other than the one or more conducting polymers; and
rehydrating the hydrogel precursor to form the pure conducting polymer hydrogel, wherein the hydrogel has an electrical conductivity of at least about 1 S cm⁻¹ in PBS and at least about 1 S cm⁻¹ in deionized water, a stretchability of at least about 10% strain, and a Young's modulus of no greater than about 20 MPa.

29. The method of claim 28, wherein the one or more conducting polymers are selected from one or more polythiophenes.

30. The method of claim 29, wherein the one or more conducting polymers are selected from poly(3,4-ethylenedioxythiophene):poly(styrene sulfonate) (PEDOT:PSS), poly(3,4-ethylenedioxyselenophene) (PEDOS), poly(3,4-ethylenedithiathiophene) (PEDTT), poly(thieno[3,4-b]-1,4-oxathiane) (PEOTT), poly(N-methyl-3,4-dihydrothieno[3,4-b][1,4]oxazine) (PMDTO), poly(hydroxymethylated-3,4-ethylenedioxylthiophene) (PEDOT-MeOH), and combinations thereof.

31. The method of claim 29, wherein the one or more conducting polymers is poly(3,4-ethylenedioxythiophene):poly(styrene sulfonate) (PEDOT:PSS).

32. The method of claim 28, wherein the one or more polar organic solvent is selected from dimethyl sulfoxide (DMSO), ethylene glycol (EG), xylene, methanol, dimethylformamide (DMF), tetrahydrofuran (THF), and combinations thereof.

33. The method of claim 28, wherein dry-annealing is performed to provide one or more tunable swelling properties of the hydrogel precursor in wet physiological environments.

34. The method of claim 33, wherein the dry-annealing is performed under mechanically constrained conditions to form a hydrogel precursor, wherein the hydrogel precursor isotropically swells to form a hydrogel in a wet environment.

35. The method of claim 33, wherein the dry-annealing is performed under mechanically unconstrained conditions to form a hydrogel precursor, wherein the hydrogel precursor anisotropically swells to form a hydrogel in a wet environment.
